(19) United States
(12) Patent Application Publication
(10) Pub. No.: US 2016/0155161 A1
(43) Pub. Date: Jun. 2, 2016

(54) METHOD AND APPARATUS FOR AN IDEA ADOPTION MARKETPLACE

(71) Applicant: Teleshuttle Tech2, LLC, New York, NY (US)

(72) Inventor: Richard R. Reisman, New York, NY (US)

(21) Appl. No.: 14/952,584

(22) Filed: Nov. 25, 2015

Related U.S. Application Data
(63) Continuation of application No. 10/692,974, filed on Oct. 24, 2003, now abandoned.
(60) Provisional application No. 60/420,887, filed on Oct. 24, 2002.

(51) Int. Cl. G06Q 30/06; G06Q 50/18

(52) U.S. Cl. CPC G06Q 30/0601; G06Q 50/184

(57) ABSTRACT

Systems and methods for idea adoption marketplaces are disclosed. These systems and methods may employ, for instance, the reach of the Internet, the frictionless commerce of electronic marketplaces, and/or the power of collaborative systems for learning and social decision support to facilitate, for example, the publication, development and/or adoption of useful inventions, whether patentable or not. These systems and methods may support the creation of rich, flexible, accessible, and/or effective marketplace processes for purposes such as creation and protection of intellectual property and/or for its development for the public good.

### CROSS REFERENCES TO RELATED APPLICATIONS

This application is a continuation of U.S. patent Ser. No. 10/692,974, filed on Oct. 24, 2003, which claims the benefit of U.S. Provisional Application No. 60/420,887, filed Oct. 24, 2002. The entire disclosures of the preceding applications are incorporated by reference herein.

### FIELD OF THE INVENTION

The present invention is directed generally to development and commercialization of inventions, and reward of inventors and contributors, and more particularly to the use of marketplace systems and social learning and decision support systems to facilitate publication and development of new ideas to the benefit of both inventors and society.

### BACKGROUND OF THE INVENTION

The advancement of civilization depends on invention, and the protection of inventions as intellectual property is highly problematic because of the conflict between open collaboration and needs for secrecy and proprietary protection. Patents seek to balance between well-known conflicts between the value of open teaching of ideas and the value of protection of intellectual property. The current official compromise results in openness being severely limited until a patent application is filed. In the US, open disclosure may occur as long as a patent application is filed within one year of first publication. However, even under US rules, such publication tends to be discouraged in practice, at least until a Provisional Patent Application (PPA) is filed, and often thereafter, for various reasons of prudence.

This lack of openness seriously impedes the ability of inventors to benefit from collaborative assistance in developing ideas in early stages, especially for those inventors lacking a private community to collaborate within (such as a large company research division). For ideas that have clear value, with readily achievable development and support prospects, this is not a problem. However, a very large number of formative ideas have less clear value and prospects. Most of such ideas are neglected, especially among inventors who lack strong institutional support. Thus many ideas, that in aggregate have very great potential value to society, are lost.

Even when patents are sought and granted, the marketplace for inventions is highly inefficient, illiquid, and opaque, with very high transaction costs. It is not easy to sell or license intellectual property rights (IPR) such as patents. Success is achieved primarily by large corporations, or by others who have both particularly valuable patents and strong business skills. Patents are often valued not directly for their contribution to the value of products and services, but as bargaining chips for defending against others who hold patents. Patent infringers can simply ignore with impunity the claims of inventors who lack the resources to risk the many millions of dollars needed to carry out a patent suit. This further discourages many inventors from developing their ideas and from trying to commercialize them.

Furthermore, even ideas that are published through the patent system or other media are very often neglected, simply because of the difficulty of focusing the attention needed to identify and promote the few good ideas hidden in a sea of noise. Also, disclosures in patent applications may become public after a significant delay period, currently eighteen months from filing in the US.

Some partial steps to apply electronic marketplaces have been made in the form of some IPR marketplaces that are aimed at well-developed IPR, such as YET2.COM, VERTICAL*I, PATEX, PL-X, and others. However these tools do not substantially change the fundamental limits of a patent system that imposes secrecy on inventors and limits the support they can obtain until they have passed significant hurdles. Meaningful, substantive disclosures of inventions are only made with selected parties under agreements of confidentiality. In many cases, postings are anonymous until a mediated introduction is brokered by the marketplace, and further interactions are often offline and external to the marketplace. Membership may be restricted to highly qualified participants. This limitation of information to superficial functional and marketing descriptions, membership restrictions, and the mediation processes and the complex agreements required to dig deeper can seriously impede idea flow.

Alternative publication services, such as IP. COM have exploited the Internet for defensive publication purposes, but these are based on the idea that such publication is meant to put all IP rights into the public domain, thus providing little incentive to inventors. Other services such a BOUNTYQUEST have sought to harness the power of broad Internet communities, in this case for finding art to invalidate patents, but again, this does not offer benefit to inventors. It has been suggested that BOUNTYQUEST can also be used to identify patent infringers, but this can be done only in the form of an isolated bounty posting, with little support for collaboration and with a very limited and narrowly applied reward structure.

### SUMMARY OF THE INVENTION

According to embodiments of the present invention, there are provided systems and methods for idea adoption marketplaces. These systems and methods may employ, for instance, the reach of the Internet, the frictionless commerce of electronic marketplaces, and/or the power of collaborative systems for learning and social decision support to facilitate, for example, the publication, development and/or adoption of useful inventions, whether patentable or not.

These systems and methods may, according to various embodiments of the present invention, support the creation of rich, flexible, accessible, and/or effective marketplace processes for purposes such as creation and protection of intellectual property and/or for its development for the public good.

### BRIEF DESCRIPTION OF THE DRAWINGS

FIG. 1 is a block diagram of an exemplary marketspace of marketplace participants and systems for implementing certain embodiments of the present invention.

FIG. 2 is a schematic of selected entities and relationships involved in the marketplace activity of FIG. 1.

FIG. 3 is a flow chart of an exemplary process, performed by the marketplace of FIG. 1, for basic collaborative item development according to certain embodiments of the present invention.

FIG. 4 is a block diagram of an exemplary process, performed by the marketplace of FIG. 1, depicting selected support subsystems according to certain embodiments of the present invention.

FIG. 5 is a block diagram of an exemplary process, performed by the marketplace of FIG. 1, depicting an alternative reward system according to certain embodiments of the present invention.

FIG. 6 is a block diagram depicting exemplary components of computing devices used to support participants, marketplaces, and other systems involved in the marketplace activity of FIG. 1.

### DETAILED DESCRIPTION OF THE INVENTION

### Basic Description

The present invention, in various embodiments, providing a system and method for an idea adoption marketplace. More specifically, various embodiments of the present invention apply the reach of the Internet, the frictionless commerce of electronic marketplaces, and the power of collaborative support systems for learning and social decision support to provide an new approach to the publication, development and adoption of useful inventions, whether patentable or not. Furthermore, embodiments of the present invention support the creation of rich marketplace processes for the creation, protection, and/or development of intellectual property.

One aspect of the present invention is its use of mechanisms for publication and for selective identification of good ideas and for fostering dialog to aid in collaborative development based on broad and deep application of social decision processes. These processes can involve direct or explicit decision inputs in the form of human rating and analysis processes, as well as indirect or implicit decision inputs in the form of metrics and analytics that infer interest, value, and authority from the content and structure of the community interactions.

Use of such methods alone could motivate publication in some cases, by providing an receptive environment for communicating ideas. Ideas might be published and accessible under a simple umbrella agreement that, to a reasonable degree, both enables open access to view the ideas and protects the inventor's rights as discussed below.

A complementary aspect is the incorporation of new methods for rewarding inventors and other contributors to the development of useful inventions. One of these methods exploits aspects of US patent law to enhance the prospects for protection and reward to inventors as additional motivation for publication. This relates to the “one year rule” that provides a one-year grace period after publication, during which an idea can be publicly developed without loss of the inventors ability to file for a US patent.

A marketplace of the present invention may structure itself to create a foundation for an alternative reward system that operates much like a shadow patent system driven by large-scale social decision support processes that might operate with or without government support. This may relate to direct compensation, and to more indirect forms of recognition and/or “moral rights,” and the like. It may apply both to patentable inventions, and to other aspects, such as know-how and/or copyright, and the like.

For a basic embodiment that exploits the current US patent laws, an electronically supported marketplace that serves as an idea “adoption agency” that could work as follows:
Inventors publish their ideas in sufficient detail to allow others to reasonably evaluate their merit. This could also be sufficient to provide enablement, at least for practical purposes, and perhaps for patent purposes as well.
Access to the publication may be open to all, or to all who agree to basic terms respecting the rights of inventors.
The basic terms might stipulate that as long as an idea may be patentable, participants recognize that a patent application may be filed or be pending, and that they may be obliged to enter into an agreement with the inventor to obtain rights to use an invention. Notification might be given as to whether patent applications are actively pending at any given time.
Optionally, if the idea cannot be patented, purely by a time lapse, such as of the one year grace period, a secondary compensation agreement administered through the marketplace might be applicable. Such an agreement might not be applicable if the idea is unprotectable for reasons other than time lapse.
The US one year rule relating to publication (or one year from filing a PPA) could allow one year for viewers to assess ideas and/or associated enhancements, seek to reach agreement with an inventor, and cause the filing of a patent application, possibly by assuring or providing prosecution funding that the inventor was not willing or able to commit.
Ideas may also be published after filing a PPA, which might then protect international and/or US patent rights for one year, while still limiting initial investment by the inventor. Such might serve to prevent loss of international rights.
An inventor may pre-specify terms for license or assignment, such as in terms of flat fees and/or percentage of royalties, and such terms might be based on standard contract templates and deal terms provided by and accepted in the marketplace.

A highly open mechanism of this kind might serve as an adoption agency for ideas that might otherwise be abandoned and lost, in some ways similar to how a human adoption agency serves as a marketplace for infants that might otherwise be abandoned and lost. Such might also be considered as a marketplace for distressed, fire-sale IPR, one that works even for very early stage IPR. Such a marketplace might not replace the current system, but instead complement and/or enlarge it.

These methods could broadly address both financial and non-financial benefits. One method is a bias toward open dialog as a way to add value, with acceptance that that may compromise some narrow proprietary rights. The value and rights that may be enhanced by this method may be those that might be compromised by current methods such as the opportunity to contribute a valuable idea to society, to gain recognition for the idea, and/or to gain collaborators who can enhance and apply the idea. As to more direct financial rewards, such methods may trade a possibly reduced slice of the pie, with less security of ownership, for the greater prospect of making a large pie from an idea that may initially have questionable prospects and backing.

A marketplace of the present invention could offer a number of new benefits to inventors.

For instance, inventors could have the ability to pursue ideas with little investment (e.g., no formal patent application filing, or only a PPA). Other potential benefits may include one or more of the following: prospects of financial and other support in obtaining a patent, and secondarily of some financial reward, if an idea gains sponsorship within the one-year limit, further potential for some financial reward through secondary compensation processes even if eligibility for patent protection lapses, potential recognition for contribution of a valuable idea, even if not compensated financially, and potential that the idea is applied and furthers society rather than being lost, even if no other compensation is obtained.

The last two benefits noted might alone be sufficient to attract significant numbers of contributions, especially if the idea might otherwise be abandoned. At least in view of some of these benefits, inventors in the market place could be said to have the ability to act as “free agents”.

The marketplace could also offer new benefits to other participants such as one or more of the following: potential commercializers of ideas could source inventions efficiently, drawing on community inputs and assessments, on relatively attractive terms, other parties could make contributions to inventive enhancement dialog, and possibly gain financial and/or recognition value for those contributions, or even co-inventor status, as well as other social/network-related benefits, other parties could serve as raters of ideas and enhancements, and possibly gain recognition, and/or possibly value, for that, and these other parties could include consultants, VCs, IP commercialization firms, and the like.

A valuable feature of a marketplace of the present invention is that it might alter the processes of developing and exchanging IP rights to finesse the usual conflicts between openness and protection. It combines methods for open collaborative development of ideas with methods for exchange of IPR to obtain value (whether monetary or otherwise) for those ideas, and does so in such a way that causes each to reinforce the other, rather than to interfere with one another.

The methods described herein, including those relating to grace period recapture, reputation and non-cash rewards, and alternative value systems, balance the conventional disadvantages of loss of protection resulting from open development of IPR, and leverage the processes supporting that open development to support the operation of the marketplace to facilitate flexible and equitable IPR exchange. The result is a virtuous circle of self-reinforcing collaboration on development, value creation, and value exchange that includes participants of all kinds working on IPR at all stages, with a variety of built-in motivators to encourage participation.

As used herein, the term “marketplace” may, for instance, refer to any physical or virtual meeting place at which buyers and sellers may meet and transact business of any kind “Buyers” may include, for instance, any party seeking items of any kind, physical, virtual, or conceptual. The term “sellers” may include, for instance, any party offering items, and the term “business exchange” may, for instance, include any exchange activity relating to items. Such exchanges, may be for exchange of value or compensation, whether monetary, barter, or for other direct or indirect benefits.

The term “Participants” may include buyers and sellers, as well as other parties involved in the activities of a marketplace, including support services such as business, legal, technical, consulting, accounting, administrative, and the like. Participants may be, for example, individuals, groups, or organizations, such as business enterprises, government, trade groups, technical organizations, and the like.

The term “community” is may refer broadly to any group of members linked by some common element or interest, including shared interests and interactions, and to include marketplace communities, or sub-communities within a marketplace community, or those that may cross multiple marketplaces. The term “marketspace” may refer broadly and collectively to the entire conceptual space in which marketplaces and their participants operate and interact with one another, the entire matrix of ideas, information, networks, and systems that link potential buyers and sellers and those who support them and interact with them.

A “physical” marketplace or community is generally based on physical meetings, and a “virtual” one, which may be used synonymously with “electronic,” generally relies on electronic communications to accomplish a virtual meeting, but these may overlap in practice so that either may include the other. Similarly, an electronic or virtual community may be one linked by electronic communications and support systems. Unless indicated otherwise or clear from context, marketplace and community may be used synonymously.

The phrase “electronic collaborative knowledge and problem solving system” (ECKPSS) may refer broadly to any kind of system using computer-based support to facilitate collaborative problem solving by human participants. Included may be social decision support systems (SDSSs) and consensus-seeking systems, learning or knowledge systems, idea management systems, collaborative communications systems, rating and reputation systems, and the like. The term “collaborative support system” (CSS) is meant to be synonymous with ECKPSS, and unless otherwise indicated or clear from context, is not meant to refer to purely manual collaborative methods that do not involve computer-mediated support.

CSS may also, unless otherwise indicated or clear from context, be inclusive of support systems for knowledge and problem solving, such as lexical, semantic, conceptual, analytical, and visualization systems, including those based on artificial intelligence (AI) and similar methods that may not themselves specifically include collaborative elements but that may be used in combination with collaborative systems as part of a broadly functional tool suite for augmenting human interactions with information and with other humans, but might not include contexts in which collaboration is entirely absent.

The term “Internet” may include the current Internet, including all devices and tributary networks which may connect to the Internet, and any future technology that may arise that serves to provide broad connectivity among people, through their computers and other communications devices.

The term “inventions” may include useful ideas and innovations of any kind, whether patentable, know-how, trade secrets, or the like. The term “ideas” may be inclusive of inventions as well as other kinds of ideas, regardless of usefulness, including those of artistic, entertainment, intellectual nature, or the like, and may also be inclusive of expressions of ideas, including forms that may be subject to copyright.

The terms “intellectual property” and “intellectual property rights” may include any and all forms of intellectual property, including inventions and ideas and expressions of ideas, and any and all forms of rights therein, including conventional forms, such as patent, know-how, trade secret, trademark, and copyright, and new forms, such as any that may be enabled by the marketplace methods described herein, whether formally or informally constituted and asserted.

As will be discussed in greater detail, features of an idea adoption marketplace of the present invention may include, for example:
Marketplace features that bring buyers and sellers of ideas, and supporting players, together in a supportive environment
Rating, recognition, and knowledge management systems that identify, assess, categorize, and draw attention to good ideas
Collaboration support features that enable inventors and others to work together to enhance raw ideas, and to maintain an audit trail of such activity.

As will also be discussed in greater detail herein, a marketplace of the present invention may aid inventors by:
Finding support to obtain a patent and commercialize an invention, perhaps exploiting the one-year window to seek support while still retaining the possibility of patent protection
Gaining non-cash value apart from patent protection, perhaps by publicizing ideas, getting feedback, collaboration, and recognition
Creating secondary IP revenue generation mechanisms, such as a “shadow patent system”, that may be feasible using contract and/or other means as an adjunct to the marketplace system
Combining some or all of these with the benefits of defensive publication

As will be discussed herein, similar benefits may accrue to buyers of ideas and support services.

### FIGURES

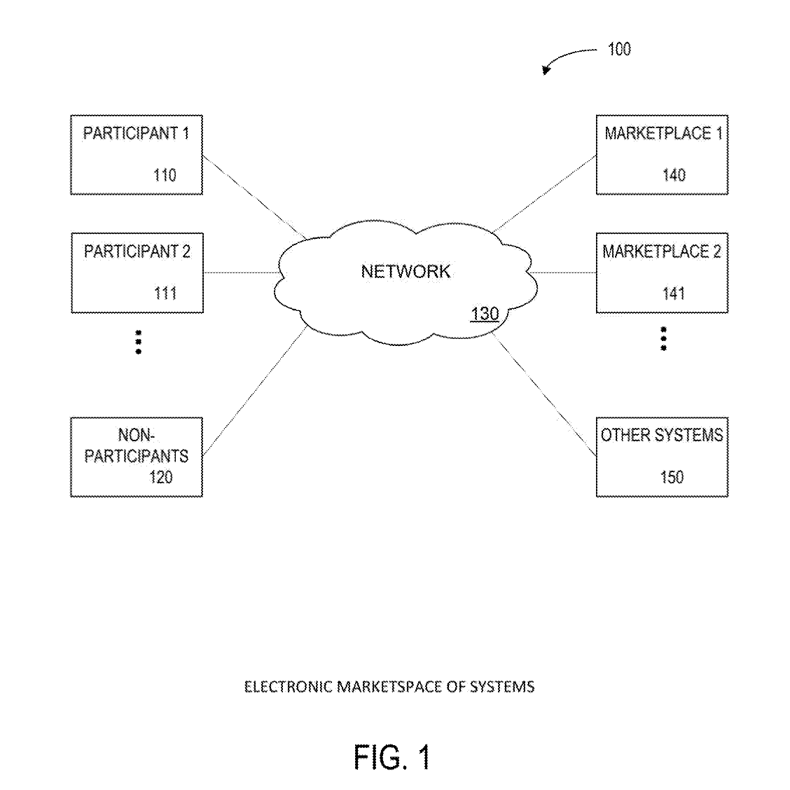

Referring now to FIGS. 1-6, various features for a method and apparatus for an idea adoption marketplace are discussed.

Turning now to FIG. 1, there is depicted an exemplary marketspace of marketplace participants and systems 100, with its system elements at participant and remote locations. An arbitrarily large population of participants 110 may be involved at various times with the marketplace activity, each using one or more participant systems connected to a network 130, such as the global Internet. A representative additional participant 111 is also depicted. Accessible to participants via the network is a marketplace 140, which may be a complex of systems as described below.

Also accessible via network may be other marketplaces 141, other systems 150, including systems that may provide services to the participants or to the marketplaces or to other communities, and non-participants 120, who may also become involved in activities related to the marketplace indirectly, or by later joining the marketplace as participants, and who may participate in other marketplaces or systems or communities. Participants 110 may operate at different levels with corresponding levels of privilege and responsibility, and multiple marketplaces 140, 141 may cooperate with one another to offer combined services and form combined communities, as discussed further below.

Participants 110 may each have a variety of roles, including but not limited to:
Idea creators/inventors
Assignees
Independent raters
Advisors/collaborators who may add value and development, but might not be “inventors” for purposes of patent law
Commercializers/implementers
Users or appliers of ideas and inventions, including manufacturers and services
End-users and consumers, including those using an invention or using the end-result of use of an invention
Investors and sponsors
Support service providers which may be fee oriented
Government/regulatory bodies
Group roles, such as expert panels and the like
Special roles, such as dialog managers or moderators, arbitrators, stewards, or the like
Other roles relevant to further applications

It is noted that each participant may participate in multiple roles. It is further noted that participants may include both individual persons and corporate or other organizational entities, and that such entities may have complex relationships, such as, for example, employee inventors and other employee roles within an enterprise which might be an assignee of an invention, and in such cases, such persons may have roles both as distinct participants and as representatives of the enterprise as a participant.

Items may be of many kinds, and may be loosely structured into item types to provide for consistency of processing of like types, and interactions among types. Such structures may be fuzzily applied, and items may include elements of multiple types. For some purposes, such as, for example, rating of reputation or authority, and for tracking of contributions, participants in any role may also be represented as items. Broad categories of item types may include, for instance:
Contribution items, which may seek to add knowledge
Need or problem statement items, which suggest problem issues and serve as solicitations for further knowledge and ideas
Rating items, which may seek to provide judgmental feedback
Support items, which may further commercial development and dealmaking
Analysis items, which may further analytic and presentation/visualization services
Marketplace process items, which may further the operation of the marketplace

Item types include, for example:
Original invention and/or idea contribution items
Enhancement and/or improvement contribution items
Assessment or support contributions, which may be inventive or not
Prior art submission items
Rating items relating to any kind of item, perhaps including participants and ratings themselves
Scheduling and/or status items
Inventorship assessment items and/or participant value contribution items
Application items
Market and end-market assessment items
Infringer and/or user/applier assessment items
Economic assessment items
Assignment/ownership status items
License/assignment deal negotiation items
Investment/venture deal negotiation items
Input value to application assessment items
Rating process assessment items
Categorization process assessment items
Analytical process assessment items
Value/contribution assessment process assessment items

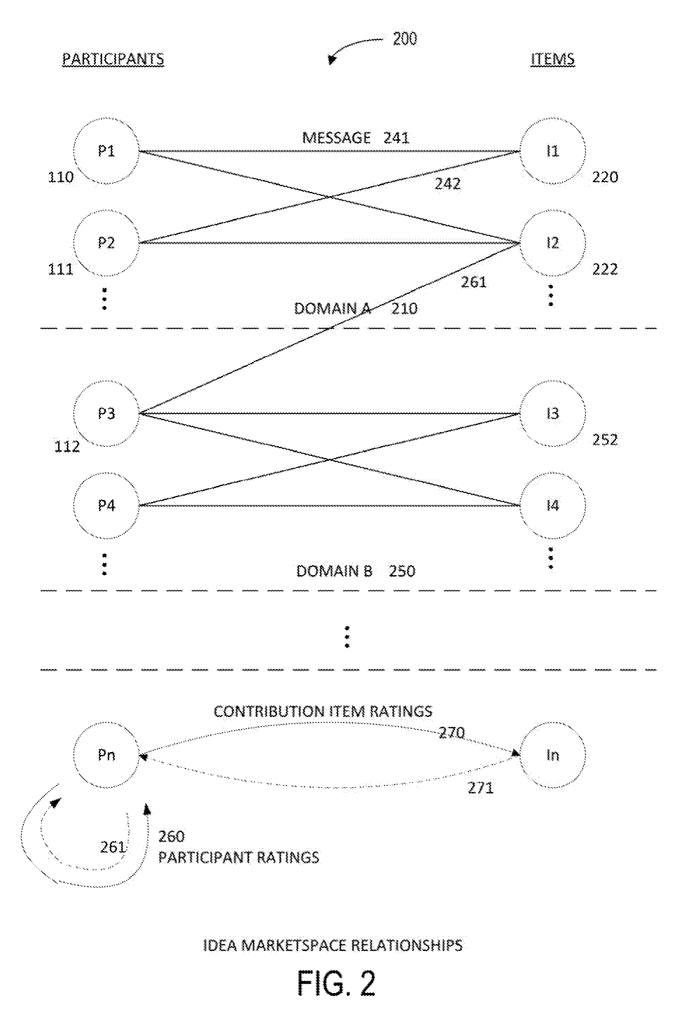

Referring now to FIG. 2, therein is depicted a schematic of selected entities and relationships involved in the marketplace activity. One set of interactions relates to participants 110, 111, 112, and the like, who may enter items 220, 222, 252, and the like, as informational submissions into the marketplace system. Submissions may be made as messages 241 from a participant that creates an item 220, and may relate to other items 222. Also depicted are similar messages 242, 261, and the like. Thus items may be atomic items corresponding to individual messages, or may be composite items, such as the subject underlying of a thread of messages. Items may be categorized into domains 210, 250, and the like.

Domains may relate to fields, such as fields of inventions, and may be subdivided as appropriate to any level of granularity. Items, participants, and messages may belong to multiple overlapping domains, and different systems of domains corresponding to different taxonomies may apply. In general, this structure may be modeled as a semantic network, and/or subject to analysis and processing using methods used for semantic networks. Such memberships may have varying primary, secondary, and lesser weights, corresponding to the level of domain relevance, whether explicit or implicit. A cross-domain message 261, from participant 112 having a primary membership in domain 250, regarding item 222 having a primary membership in domain 210 is depicted as an example.

Layered onto this basic level of contribution items, may be ratings items, in which participants provide feedback and collaborative evaluation. These may include contribution item ratings 270, participant ratings 260, and/or ratings of other kinds of items. Each such rating may come from a participant with regard to an existing item (or a concurrently submitted item), but may also reflects back upon the participant making the rating 271 and 261 in a way that may be subject to further ratings by others.

Ratings may apply to any combination or aggregation of entities including, for instance, ratings by a participant associated with their own submission item, ratings of an item or set of items submitted by other participants, ratings of a participant with regard to an item or a group of items as a body of work, ratings of individual or aggregate ratings, and ratings of rating systems and methods.

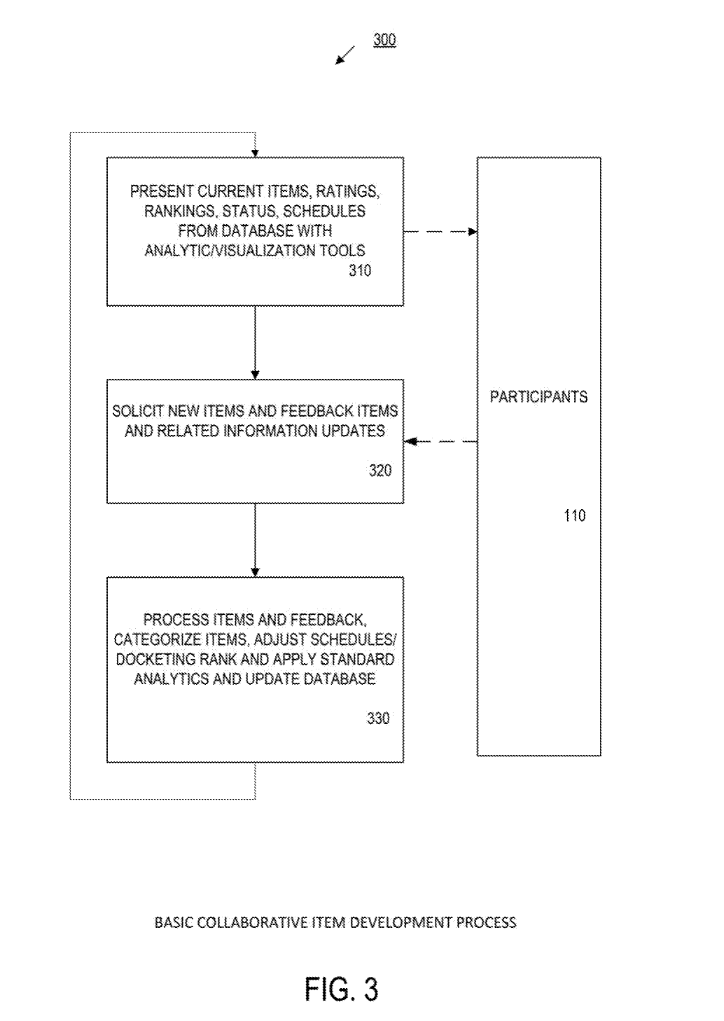

Turning now to FIG. 3, therein is depicted the flow of the basic collaborative item development process 300. This portrays how feedback may be used to exploit the social learning and decision processes of the participant community to enhance the workings of the marketplace. The process begins as a participant 110 interacts with the marketplace systems, and the system presents views of items from the marketplace database (step 310). Depending on the task, various presentations may be provided, including summary or detail of items of selected types and categories showing ratings, rankings, status, schedules and the like, in conjunction with various analytic and visualization tools.

The participant may continue review in what may be a highly interactive series of views, searches, aggregations and drill-down steps, and the marketplace system solicits new items from the user, which may include, for example, new ideas/inventions, other contribution items, feedback items, and other kinds of support and information update items (step 320). The items themselves may be rich hypermedia submissions, with attachments, graphics, spreadsheets, CAx tools (computer-aided design/manufacturing/engineering), other visualization aids, and external links, and they may be created with tools that encourage and facilitate effective structuring for various types of items.

These items and feedback may then be processed by the marketplace system, including, for example maintenance of explicit and implicit thread and relationship structures, categorization of items, determination of associations with other items, adjustment of schedules and docketing processes, ranking and application of standard analytics, and the results used to update the database (step 330). This process may then repeat as database changes are presented to participants, and the participants may continue to interact with the marketplace system, and through its mediation, with one another.

This core feedback cycle may repeat indefinitely in an ongoing learning, evaluation, and/or discovery process, building rich threads of dialog relating to inventions, through the stages of their life cycle. As discussed further below, this life cycle may run in parallel at many micro and/or macro levels, perhaps addressing ideas and inventions, sub-aspects of ideas and inventions, and/or the larger cycles of ideas and inventions creating new needs and problems that lead to further ideas and inventions. The process may be open to new participants, and to external systems and services. The process may vary in details for different subgroups of participants and items, such as regarding different domains, different stages in development life cycle, and/or other task-related criteria. Variations on this basic feedback process and its CSS methods may also be applied to other support tasks and processes relating to the marketplace and the related work of participants, including some described below.

As described, this embodiment of the process features the use explicit ratings and analysis inputs from the human participants. As discussed further below, a complementary aspect of this method, that can partly substitute for and/or may effectively supplement explicit rating and/or analysis input to varying degrees in alternative embodiments, may be based on the use of implicit information that can be inferred from the content, structure, and pace of social interactions, perhaps as reflected in the record of these interactions that can be observed and maintained by the marketplace systems.

Thus a strategy may be that network-based collaborative rating aids be applied to all ideas and/or enhancement submissions to draw critical attention to well-rated ideas. This could also give incentive to inventors. Given that large numbers of ideas of uncertain merit could potentially be posted, methods of discriminating and highlighting the superior ideas may be important to give contributors some confidence that their good ideas will not be lost among this chaff, that signals will not be lost in the noise. These may include manual/editorial aids and/or fully automated AI and rule-based aids, but particular power may be obtainable from man-machine-network aids like collaborative rating methods, such as, for example, collaborative filtering and variations discussed below, and search methods based on such weightings, including, for example methods akin to those used in GOOGLE and DIRECTHIT.

To contribute to the effectiveness of the social process support provided by the marketplace, it might be desirable that all dialog on the substance and further development of an invention be tracked through the system (perhaps directly or via external hyperlink), and could be a condition of the user agreement, perhaps only until mutually waived by involved participants. Such could provide a centralized audit trail that could be searched to prevent fraud and/or theft of ideas and could help establish inventorship of enhancements. Such could also provide transparency to give inventors some confidence that recognition might be expected, and that they might maintain reasonable visibility into the ongoing development and application of their ideas. Naturally, methods that will be apparent to those skilled in the art might be used to ensure the integrity and preservation of such audit trail data.

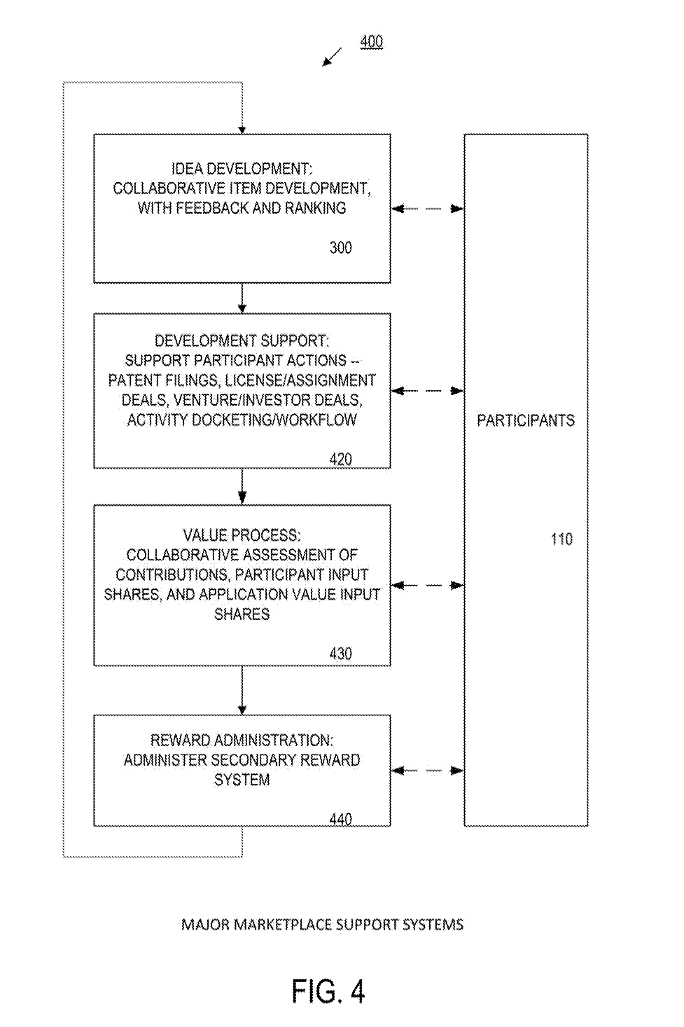

Referring now to FIG. 4, therein is depicted an exemplary block diagram of a suite of support subsystems 400 that might be found in one embodiment of an idea adoption marketplace, showing a number of component processes. One subsystem is the basic idea development process 300 just described. Many other marketplace support subsystems can also build on a collaborative feedback process like that described in FIG. 3, and these may interact in an open and flexible manner. A second subsystem is the development support process 420, which may support participant actions and workflow related to idea development, including business and logistics aspects such as patent application filings, license/assignment dealmaking, investor/venture dealmaking, activity docketing and workflow.

A further major subsystem which may be provided in varying degrees of sophistication in different embodiments supports a value process 430 to seek to compensate contributors in order to encourage contributions. This may include collaborative assessment, perhaps using a feedback process based on the same methods as for idea development, to assess contributions, the relative input contribution share attributable to participants, whether inventors or otherwise, relevance of inventions to applications and/or the value input of such inventions to the application. Such may provide a basis for apportioning value to contributors, whether purely in the form of recognition or in monetary or other forms of real value. Embodiments may further assess participants who apply inventions to compensate for the value received, and to fund compensation to contributors. A further process in support of that may be the reward administration process 440, which effects the compensation flows and manages payables and receivables processes.

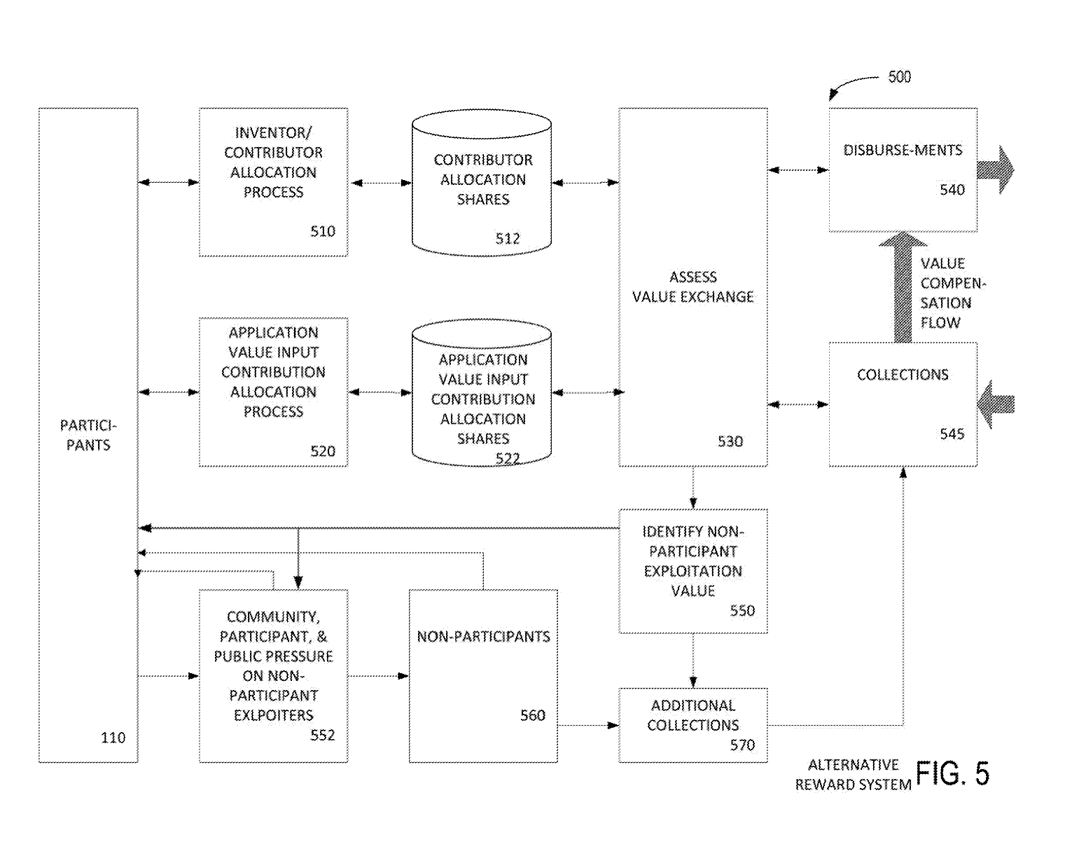

Turning now to FIG. 5, therein is depicted an exemplary block diagram of an alternative reward system 500 showing more detail of the value process 430 and the reward administration process 440 for an embodiment that includes assessments to application users. Participants 110 may interact with an inventor/contributor allocation process 510 using feedback processes like that of FIG. 3, to determine contributor allocation shares 512. A parallel activity may support participant interaction to conduct an application value input contribution allocation process 520 to determine application value input contribution allocation shares 522, both participating and non-participating. The results of these processes may be combined in a process to assess the overall value exchange 530. Such may determine what value is due from application users, what portion can be expected from participating users, what value compensation may be due to contributors, and/or what portion that can be expected from participant uses. This may feed a collections process 545 and/or a disbursements process 540.

In addition to this flow largely internal to the marketplace community, a secondary process may be applied to address non-participating application users who may be exploiting the value created by the community. As part of the community assessment process, a sub-process may identify non-participant exploitation of value 550 to determine the applications and/or entities concerned, and/or the respective value amounts. This may then feed back to participants 110 and/or to a further process in order to apply community, participant, and/or public pressure on non-participants 552. Such may be accomplished by processes supported directly by the marketplace, and/or by external action such as, for example, through media, government, and other influence points. Such may presumably influence some non-participants 560 to join the community, either as full participants, or as limited participants in the value exchange process. Such might also lead to possible additional collections 570, which may feed into the overall collection process 545 and to add the flow to contributors.

It should be understood that a rich substructure of services, interest groups, roles, and/or sub-communities may be developed within this overall context, perhaps by design and/or natural evolutionary development, and that the support tools described here can be configured and adapted to more fully serve these specialized needs in ways that will be apparent to one skilled in the art. Sub-communities of participants having common roles may be formed, to support the activities and contributions of these roles, both in aggregate, and by domain, with particular embodiments of the support systems tuned to each. In a broad sense, this marketspace can take on much of the richness of society at large, with its own ecology, institutions, and economy.

Some of this richness can be understood in terms of complex networks in multiple dimensions, both within a marketplace and its sub-communities and across marketplaces and other communities. These dimensions may include subject domains, organizational and enterprise communities, communities of practice relating to generic practice areas (which might involve multiple domain dimensions, and relate to many tasks or inventions, and might be highly informal and open), communities of task relating to specific work tasks and projects (which might relate to specific inventions and involve multiple practice dimensions, and which might be more structured and restrictive), communities of interest relating to common interests, and communities of passion relating to support and evangelism, as well as support communities providing facilitation, infrastructure, moderation, mediation, arbitration, resource management, and/or other administrative services.

As discussed further below, the functions described herein may extend to cooperating federations, confederations, or open assemblages of marketplaces, as well as other kinds of electronic communities, and some functions may be provided to work across such multiple community systems. Global searching across marketplaces and related systems could be achieved by a variety of means, including use of consolidated search indexes and search engines or use of metasearch engines.

Common multiple posting and collaboration functions, and application of business rules that harmonize or mediate across marketplaces could be provided by use of Web services based on XML (eXtensible Markup Language) and SOAP (Simple Object Access Protocol), and/or other related or similar Internet application integration technologies, such as those being developed for other B2B exchange and integration support services, including UDDI (Universal Discovery Description & Integration) and WSDL (Web Services Description Language) for example. The details of such integration methods will be apparent to one skilled in the art, based on the teachings herein.

Some current directions which may be useful in this regard are subject of the conference “International Workshop on Rule Markup Languages for Business Rules on the Semantic Web 14” (June 2002, Sardinia, Italy), the conference being in conjunction with the First International Semantic Web Conference (ISWC2002). The conference description Web page notes:
“The Semantic Web offers a research perspective for automating business processes. Rule markup languages, that allow to express business rules as modular, stand-alone units in a declarative way, and to publish them and exchange them between different systems and tools, will play an important role for facilitating business-to-customer (B2C) and business-to-business (B2B) interactions over the Web. Derivation rules can be included in an ontology to define derived concepts on top of base concepts. In this way, for instance, derived business terms, such as customer categories, may be defined. Whenever a rule refers to an incomplete predicate, for which explicit negative information has to be represented along with ordinary (positive) information, a second negation, supplementing negation-as-failure, is needed (as in the formalism of extended logic programs). Using this negation in the head of a rule, one can express conflicting rules that may defeat each other. Such a language for defeasible rules is useful to represent business rules allowing for exceptions. In addition to derivation rules, there is another type of rule which allows to specify the reactive and communicative behavior of a system or agent: reaction rules—in other contexts also called event-condition-action (ECA) rules or triggers. Business rules that specify the various steps of a business process can be encoded in the form of reaction rules. A general markup language for business rules has to accommodate these different types of rules and support their interoperation.”

It is noted that rule-based methods may be helpful in supporting the functions addressed herein at a number of levels, such as, for example, within and across marketplace, community, or other service systems (including enterprise systems), within a user's own computers and support systems, such as in the form of a user agent, and in providing complex intelligent integration services across user and service systems, such as using mobile agents that perform functions on a user's behalf at one or more remote service facilities.

This discussion draws on a developing body of art in the general area of collaborative support systems, particularly learning, knowledge, and discovery systems and social decision support systems, to suggest specific methods relevant to an idea adoption marketplace. Some of that work is summarized in the December 2001 Communications of the ACM: Collaborative Technologies, and in Turoff, Social Decision Support Systems (SDSS) (HICSS-35'02), incorporated herein by reference. Related work on reputation management has emerged in use of Web-based services such as AMAZON, EBAY, GOOGLE, and OPENRATINGS, and been subject of research at the MIT eBusiness Center, led by Dellarocas, summarized in a working paper, The Design of Reliable Trust Management Systems for Online Trading Communities (Oct. 4, 2000), incorporated herein by reference.

Underlying these methods, and applicable to embodiments of the marketplace in various combinations may be the full suite of current and emerging communications methods, both conventional and computer mediated. These may include synchronous or realtime methods, including in-person, telephonic, teleconferencing, text, audio, and video chat or conferencing, collaborative virtual environments (CVEs), and asynchronous methods, including mail and physical publication, e-mail, SMS (Short Message Service), and other messaging, bulletin boards, discussion groups, newsgroups and similar threaded conferencing systems, Web sites, Weblogs, knowledgebases, databases, content management systems, visualization and virtual reality (VR) systems, Lifestreams, and related support structures, whether based on file structures, relational, object, or other databases, tuple spaces, or other communication and information technologies.

To the extent that communications media that are not digital or computer based are used in conjunction with the methods addressed here, it may be desirable to combine them with computer-based methods to record, interpret, and process them, such as using speech and image recognition methods, to support the use of automated methods for processing such information in ways similar to inherently computer-based media.

Additional methods that aid in applying these communications and the knowledge that underlies them include information discovery techniques, including automated and human-aided classification methods, taxonomies and concept/semantic mappings to aid in matching ideas, and in finding people who have interests that correspond, or who have relevant expertise. A variety of methods emerging for information filtering and discovery, and for competency discovery are applicable, as are other related methods in the broader areas of knowledge management systems, workflow systems, and business rules systems.

Some of these are described in GIGA INFORMATION GROUP reports, incorporated herein by reference, on Knowledge Management (Jun. 29, 2001), Classification Technologies (Aug. 21, 2001) and Competency Discovery (Dec. 17, 2001), and include such areas as groupware, case-based reasoning, sensory networks, categorization and tagging, expertise and competency discovery, capability mapping, unstructured content visualization, unstructured content integration, artificial intelligence, learning systems, inquiring systems, rules engines, neural networks, pattern recognition, thesauri, controlled vocabularies, feature extraction, semantic analysis, linguistic recognition, ontologies, clustering, thematic and topic mapping (including information landscapes, maps and spaces), hierarchy generation, searching, data mining, citation analysis, dialog management (including management of answers, questions, and response processes), and personalization. Additional relevant methods are discussed in the section on ratings, below.

A specific class of collaboration support that involves some similar issues of idea development and provides some collaboration support methods that can be adapted to the needs addressed herein is that of collaborative product development (CPD). Some background on such systems is provided in a GIGA INFORMATION GROUP report on Choosing the Right Collaborative Product Development Solution (Apr. 1, 2002), incorporated herein by reference, which characterizes them “These solutions are intended to promote interaction and collaboration among engineers and people in other roles both within a company (e.g., procurement, executive management, manufacturing) and at trading partner organizations (e.g., suppliers, customers, contract manufacturers).” Noting the areas of functionality identified by GIGA for such enterprise CPD systems—with some selected comments from that report—we find:
1. Project and program management . . . . A Web interface gives project leaders a dashboard for tracking project status, issues and developments, and team members can access and manage reports, tasks and events.
2. Portfolio management
3. Supplier interaction
4. Shared visualization . . . . Shared visualization tools enable product development team members to display and share (e.g., view, markup, redline, annotate, save changes to) complex 2-D and 3-D data from a variety of CAx sources.
5. Collaboration tools . . . . Synchronous collaboration tools include chat, video integration (images from a video camera installed on one user's computer monitor are transmitted to other users via the Web) and electronic whiteboards (shared freehand drawing tools). Asynchronous tools include discussion groups, e-mail integration, expertise mapping and question-and-answer documents
6. Workflow . . . . Workflow allows companies to automate processes that previously took place on paper or via phone, e-mail and face-to-face interactions. Workflow is used to manage engineering and product changes, track project-related action items, and track issues and resolutions.
7. Product data management (PDM)
8. Process improvement measurement

An invention adoption marketplace may adapt such methods to the needs of an open community, and as noted below, might also interact with such enterprise communities and their CPD support systems. Further detail on the adaptation of such methods is provided below.

This discussion has highlighted the basic methods as applied to some of the important subsystems of the marketplace and community, working within the global marketspace. Additional aspects are described in the following sections, along with other aspects of the invention life cycle to which similar methods apply, the details of which will be apparent to one skilled in the art, based on the teachings herein.

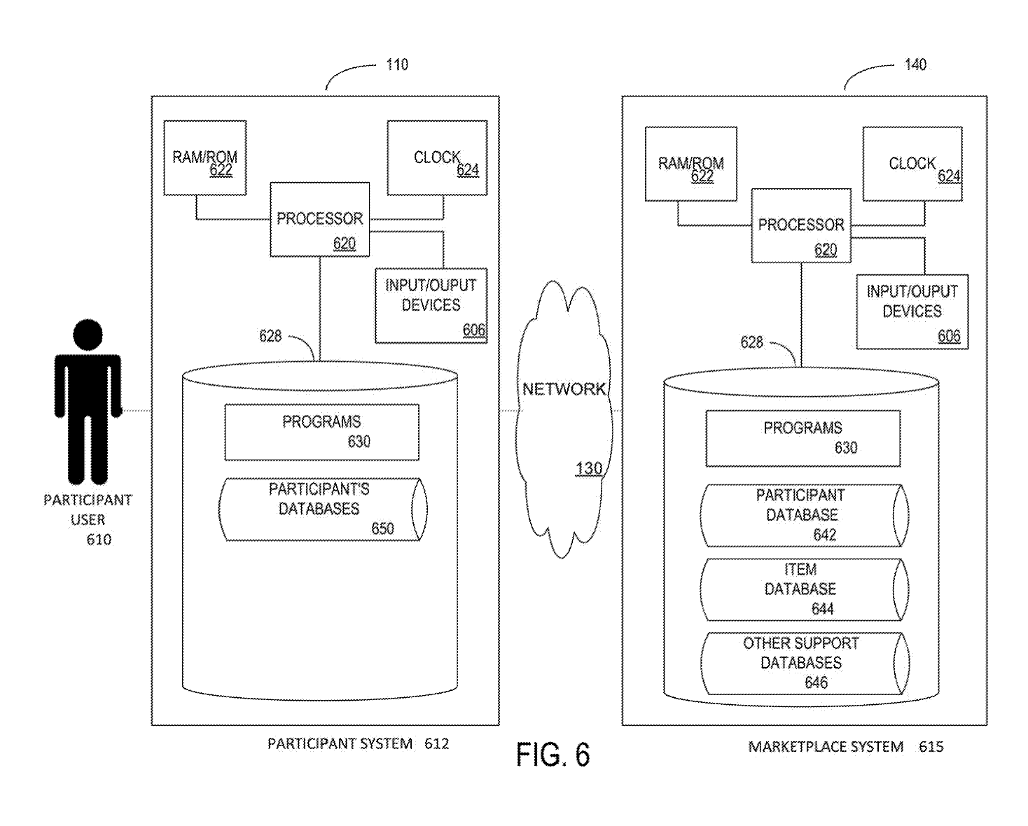

Turning now to FIG. 6, displayed therein are exemplary components of computing devices used to support participants, marketplaces, and other systems. It should be understood that any of participants 110, marketplaces 140, and other systems 150 may share similar configurations. However, for sake of brevity, the discussion immediately below will refer to the participants 110 and marketplaces 140 only. It will also be understood that participants 110 may consist of participant human users 610 working with participant systems 612. Marketplaces or other systems may similarly consist of marketplace systems 615 or other systems, as well as associated support staff personnel, not shown. Unless otherwise indicated or clear from context, participants will be understood to refer inclusively to participant human users and their supporting participant systems, and marketplaces to similarly refer inclusively to marketplace systems and any supporting staff.

The primary component of participant 612, marketplace 615, and other systems is a processor 620, which may be any commonly available microprocessor, such as the PENTIUM 4 manufactured by INTEL CORP. The processor 620 may be operatively connected to further exemplary components, such as RAM/ROM memory 622, a clock 624, input/output devices 606, and a mass memory 628 which, in turn, stores one or more computer programs 630, and databases, such as participant database 642, item database 644, and other support databases 646, which might include databases used in support systems 400, as well as participant's databases 650. These databases may be integrated with one another or further subdivided.

The processor 620 operates in conjunction with random access memory and read-only memory (RAM and ROM) in a manner well known in the art. The input/output device(s) 606 may be one or more commonly known devices used for receiving system operator inputs, network data, and the like and transmitting outputs resulting therefrom. Accordingly, exemplary input devices may include a keyboard, a mouse, a voice recognition unit and the like for receiving system operator inputs. Output devices may include any commonly known devices used to present data to a system operator. Accordingly, suitable output devices may include a display, a printer and a voice synthesizer connected to a speaker. Other input/output devices 606 may include a telephonic or network connection device, such as a telephone modem, a cable modem, a T-1, T-2 or T-3 connection, a digital subscriber line or a network card, wireless transceiver, or the like for communicating data to and from other computer devices over the computer network 130.

The mass memory 628 may be an internal or external large capacity device for storing computer processing instructions, computer-readable data, and the like. The storage capacity of the mass memory 628 is typically measured in megabytes or gigabytes. Accordingly, the mass memory 628 may be one or more of the following: a floppy disk in conjunction with a floppy disk drive, a hard disk drive, a CD-ROM disk and reader/writer, a DVD disk and reader/writer, a ZIP disk and a ZIP drive of the type manufactured by IOMEGA CORP., and/or any other computer readable medium that may be encoded with data and/or processing instructions in a read-only or read-write format. Further functions of and available devices for mass memory 628 will be apparent.

The mass memory 628 preferably stores, inter alia, a plurality of programs 630 which may be any one or more of an operating system such as WINDOWS XP by MICROSOFT CORP, and one or more application programs, such as a web hosting program and a database management program of the type manufactured by ORACLE, each of which may be necessary to implement the embodiments of the present invention. The programs 630 preferably also include processing instructions for accomplishing communication of data with between the various systems, as described herein. Accordingly, the programs 630 may include a web hosting application. The web hosting software may include functionality sufficient to read JAVASCRIPT, Hypertext Markup Language (HTML), Extensible Markup Language (XML) and other similar programming languages typically used in conjunction with hard-wired or wireless Internet applications.

The programs 630 may also use advanced Internet application integration (IAI) methods based on Web services, Simple Object Access Protocol (SOAP), Java Message Services (JMS), or other remote messaging and method invocation middleware techniques, or Agent Control Languages (ACLs). The programs 630 preferably also include a database management program, such as of the type commonly manufactured by ORACLE CORP. to save, retrieve and analyze data. The programs 630 may also include other applications, such as VISUAL BASIC or JAVA, to allow an operator to program specific functions to be performed as described herein. The programs 630 thus cooperate to form a system which operates in the manner described further below. Participant system programs 630 may also include Web browsers and/or other participant support programs.

The mass memory 628 preferably also stores a plurality of relational, object-oriented, XML, or other databases, and the databases 642, 644, 646, 650 and others described herein may be configured into any number of relational databases. In addition, configurations other than database formats, including use of XML formats or other standard and/or self-describing formats may be used to store the data maintained in exemplary databases 642, 644, 646, and 650.

Although the embodiment described herein involves components of typical computers and network servers, other existing or future technologies which perform similar functions may be employed. One such variation is the blurring of server and enterprise boundaries involved in the use of so-called “Web services” in which functions typically performed by a single server complex operated by a single enterprise may be “distributed” so as to integrate component services provided on remote servers operated by independent enterprises into a cohesive “virtual server” offered by the combined “virtual enterprise.” A similar variation is the use of “application service providers” (ASPs) to outsource such services. Also clearly intended is the use of multiple cooperating servers, as well as the use of multiple cooperating client systems, as well as the use of mobile agent technologies.

Variations may include assemblages based on combinations of downloadable programs, plug-ins, applets, aglets, or other distributed components and the use of removable components such as smart cards. Such assemblages may include elements controlled, managed and possessed by any combination of the participant, the marketplace, or any other party. Thus, for example, elements that might be implemented on participant systems 612, might alternatively be provided in an ASP mode by a marketplace systems 615. Future embodiments of participant systems 612 may be based on a wide spectrum of intelligent devices including cell phones, PDAs, wearable computers and sensors, and the like, and may involve mobile applications that move from device to device, as needed.

It is also to be understood that while the discussion herein is in terms of conventional electronic digital computer systems, future equivalent technologies might also be used. Such alternative technologies might include optical, photonic, quantum, molecular, or organic computing systems, and the like. Accordingly, it will be understood that references herein to electronic marketplaces and electronic or computer-based communities and support systems, and the like are meant to be inclusive of embodiments based on such future technologies as well.

### Rating and Reputation

Support for ratings and reputation management may be important in enabling the open collaboration that is sought to bring maximum value of contributions into the marketplace. This may apply not only to the open submission of new ideas from the widest practical range of sources, but to similar openness in solicitation of further contributions that may add value in various forms at any stage of development.

By using ratings and reputation management, large numbers of contributions might be accepted from a very wide variety of sources, without overwhelming the marketplace. Instead of restricting contributions before the fact, to those participants that meet more or less rigorous qualification standards, the marketplace can filter contributions after the fact, in a way that is relatively open to unknown and untested sources, yet focuses attention on those that appear to have merit, in an ongoing collaborative learning process.

This also enables that project or task teams focused on a particular invention or idea or other task need not be pre-defined and pre-selected, but can be dynamically constituted based on the flow of contributions, thus minimizing restrictions on what might be a valuable flow of contributions from diverse outside sources. Even in cases where project or task teams are defined to have a stable and well-qualified inner circle of core workers, such methods could permit a supplementary outer circle of activity that is reasonably open to all.

Systematic and broad application of attention direction and discovery tools can be used to draw attention to ideas based on various combinations of factors of rating, rater, perceived value, and development stage, time, and cost expectations. As a result, highly rated ideas could bubble up, especially those with high potential promise and feasibility, and with credible, authoritative advocates. Further, multiple complementary views and analytics and other promotional mechanisms could filter and promote ideas based on newness, level of development, potential value, level of help needed, etc.

Such methods could useful beyond the immediate application to the idea adoption marketplace to be broadly useful for any kind of collaborative information medium. This could include evaluation, popularization, and development of all kinds of ideas, products, services, and the like. For example, such methods could be applied to ideas in politics, society, philosophy, religion, and to products and/or services in art, entertainment, and consumer and business products and services.

These rating and reputation processes may be applicable not only to the ranking of the ideas themselves, but also to maintaining quality of participation in the face of the highly open membership that is contributory to the objectives of the marketplace. Just as ratings of items allow for large numbers of ideas to be submitted, with the cream rising to the top, ratings of participants and their submissions may also allow for large numbers of participants, with the cream gaining the greatest influence and authority.

Some features that might be useful in ratings-based attention systems include the following: Ratings could be done both for items and for participants, as well as for ratings and systems of ratings, and broadly, for all aspects of the marketplace and its methods. Participants may be categorized by their role (with support for multiple roles), and all may contribute ratings, and these can be analyzed in terms of role, both the role(s) being rated and the role(s) of the rater. Both ideas and participants may be partitioned in terms of content domains. Raters may have distinct ratings in one or more domains of expertise, and varying ratings in other domains. Participant ratings can have a component based on objective qualifications (education, experience, position, etc), as well as by community feedback, and this also may vary by domain. Ideas may be categorized by stage, scale, value, importance, etc.

It may additionally be useful that inventors can position their ideas in terms of the confidence of their own ratings of them. Thus an inventor (or other participant) could stand behind one idea, and have it both draw on and affect his reputation (giving it more confidence, but at a possible cost in reputation depending on how it turns out to be received), while casually throwing out another idea with qualifications that give it less weight and protect his reputation. Confidence can be based on inherent uncertainty in an analysis or on lack of diligence in analysis, with different implications to each. Ideas may thus inherit pedigree ratings associated with their creators and other contributors. An idea that is from a highly rated creator put forth as highly promising with high confidence, and with strong ratings from highly credible raters could score very high, even with few inputs. Analysis can track and weigh both the confidence given by the rater and the credibility of the rater.

Embodiments might also provide that ratings of ideas can be split into various factors, including one or more of those such as: Distinct ratings for the promise of the idea, and for the confidence in the rating—this provides useful information, such as for an idea that is thought highly valuable with high confidence, one thought highly valuable but with low confidence, one thought moderately valuable with high confidence, and the like. Categories for a complex value expectation profile, in terms of expected values, high and low range projections, scenarios relating to level of development and marketing effort, varying time horizons and internal rate of return (IRR) discount factors, expected values, options pricing models, real options, Total Economic Impact (TEI), and the like. Characterizations of the expected effort to develop the idea, and the readiness and effort to development of a market for it.

Additionally, ratings of ideas may be categorized to distinguish: IPR Value—likelihood and value of patent protection, commercial Value—potential benefit to a business applying the idea, even if not protectable, and social Value—potential benefit to society, even if not material to any company.

Similarly, raters may be categorized to distinguish: general reputation and expertise, topical and/or domain reputation and expertise, level of confidence (how strongly does rater feel about the rating), and level of attention (to distinguish ratings based on quick reaction versus after deep study).

It is noted that ratings could be characterized over time. Different meanings can be drawn from initial idea ratings and ratings after some feedback and development (and “current” ratings), and similarly for participant ratings over time, with different kinds of actions having effects that decay at appropriate rates. Time profiles could produce metrics of momentum, velocity, and acceleration of ratings and attention to characterize the recognition trend, and patterns could be searched for, much as for stock market prices and metrics. Post-audits after varying periods can make hindsight adjustments, and that can be especially valuable in refining participant ratings, thus adjusting for lone contrarians or voices in the wilderness that prove right, allowing such players to be identified and sought. Analysis of ratings patterns over time can be helpful to assess and adapt the basic rating methods.

It is also noted that methods might be used to seek to ensure that all ideas get some minimal level of review, and that those showing apparent promise get deeper review. This can include volunteer review groups that agree to serve a duty reviewers to screen ideas in specific fields, such as with one or a few raters screening each newly submitted idea, and a full panel screening those that pass some threshold. Raters can gain credit for doing such reviews, and for the timeliness and quality provided. Multiple such groups can exist, with different styles and perspectives, each generating group ratings of its own, and an idea can have multiple sets of such feedback.

Further, automated and semi-automated support can be applied to update base descriptions to reflect feedback. Problems and solutions can be rated, and tools can be used to structure and append summaries of both problems or issues relating to an item that are well addressed, and those yet to be well addressed. Gap and opportunity analysis can highlight open problems, both as a concern, and as an opportunity for more value to be added, both to the current invention, and as an opportunity for further invention.

Additionally, collaborative filtering methods can be applied to aiding in finding items that are well rated by participants with rating patterns that correlate with a user, both for individual item searches and to feed back to identify other raters with common views. Such methods can be localized for use within specific groups of raters. Variations on such methods can also be used to find groups of participants who favor or disagree with a given viewpoint, so that further methods can be applied within such subgroups.

Dialog manager, moderator, or similar facilitator roles can be used to assist in organizing dialog trails, and in updating base descriptions based on feedback. Such a role can be filled by the creator or a delegate, by volunteers, by marketplace operator staff, or by support services.

Other useful methods may be transferable from other current and future work in rating and reputation systems and related CSS methods, as will be apparent to one skilled in the art based on the teachings herein.

The above-described aspects may provide a three-dimensional structure of interrelated idea and participant ratings across a dimension of content, as described with regard to FIG. 3. Of course these dimensions may take on multiple sub-dimensions, such as those noted above.

The huge potential variety of ratings types and the massive data behind that may require powerful analytic and visualization tools to help users make sense of them. Sophisticated users may want to have flexibility in how these analytics are used in various cases, while casual users may want simple metrics and presentation formats that are ready-made and easy to understand. There may be multiple weighting systems that vary by content domain, stage of development, and by search/development task type. This could be permitted to evolve, as better rating systems and analytics are developed and tested in practice.

The development of such metrics and analytics could be made open to any user or specialized provider of such services, and the rating data may be accessible (perhaps with suitable privacy controls) for such open use. This could be analogous to the ability of financial analysts to apply their own proprietary analytics, or those of specialized vendors, to financial market data.

Search/evaluation tasks may vary in such aspects as searching for specific problem solutions, for ideas in a specific domain, or broadly for ideas at certain stages or levels of potential. Searches could vary for participants with different roles. Tools can be tailored to offer different kinds of searches depending on such variables. Alerts and standing, stored searches could have similar flexibility. The shape and mixture of these CSS tools should itself be flexible and evolving based on the same kinds of processes, as described further below

Paralleling the use of explicit ratings, similar processes and structures for inferring implicit ratings could also be applied, and implicit and explicit information could be tightly integrated into a single process. Some examples of implicit information used to infer social decisions are surveyed by Kleinberg, Hubs, Authorities, and Communities, in ACM Computing Surveys, December 1999, incorporated herein by reference. This work notes that hyperlinked structures can be represented as directed graphs, with pages as the nodes and links as the edges, and that analysis of this graph structure, such as citation analysis, can provide insights into importance and authority.

As described herein, similar methods can be applied to the structure of participants and items (nodes), and to the detailed (edge) structure of messages and threads, including the ratings, contributions, and other kinds of items and entities and their relationships. Similarly, as noted above, the structures in the marketplace system may be modeled as semantic networks. Thus, as will be apparent to one skilled in the art, many of the methods of analyzing graphs and semantic networks may be applicable, both in regard to the rating and reputation processes, and to the other methods supportive of the marketplace. It will be understood that some of these networks may be referred to as “social networks,” and some of these methods and systems as “social network applications.”

Methods for facilitating this feedback process include provision of a rich suite of tools for visualizing and analyzing the database of interactions. Some work that may be applicable to these needs, including tools related to electronic bulletin boards, chat, and other collaborative systems, was the subject of the April 2002 Communications of the ACM: Supporting Community and Building Social Capital, incorporated herein by reference.

In addition to the methods described above, some useful methods include social translucence, which provides tools for providing visible representations of the presence and activities of other people in online communities, including social proxies, which provide visualizations of people and their collectively interacting activities, semantically derived visualizations on online conversations, including thread trackers that show conversation properties such as speed, life span, participant activity patterns, and thread domination, community of practice mind maps, and/or other social accounting metrics and visualization metaphors and architectures that evocatively and symbolically describe behavior in social cyberspace in multiple dimensions. Some representative projects embodying certain of these methods include Babble, Coterie, PeopleGarden, Loom, and Netscan.

Some specific aspects of how CSS tools can be applied to the needs of this marketplace are outlined herein. Discussion formats for organizing dialog and maintaining a history for review and audit can be enhanced by structuring such dialog not only as threads related to a given idea, but in task-oriented dimensions. Current threaded formats have the problem of isolation and discontinuity, and being rather haphazard in creation, browsing, and searching. Organizing dimensions might include conventional thread identity and sequence and time, disclosure segments or aspects that correspond to the sections of a patent application, disclosure, and/or similar specifications, and other dimensions such as development stage, problem/solution sets, prior art challenge/response sets, market strategy discussions, and the like.

Such aspects may enable the set of discussion elements to be viewed in any of the various dimensions, as needed, such as threads by disclosure segment, all comments by a given party at a given stage, and the like. Searching and linking elements across ideas that have some defined or inferred conceptual relationship may also be useful, such as for families of related ideas, or for parallel methods in different fields, possibly based on patent mapping techniques.

Community tools might also be applied to enhance categorization and searching. Automated categorization can be applied based on semantic and other machine analysis, with human adjustments factored in by creators and other participants. For instance, categorization might apply in dimensions addressing both the method and the application. This can support cross-fertilization of methods to additional fields of application. Subject categorization by field might be multidimensional, and participants can rate the fit—to support/dispute/or adjust classifications of items into categories, and to evolve the category structure(s) itself. Further, participants might suggest additional categories (and applications) for items. Additional participants can reinforce those suggestions and cause them to bubble up.

These methods might be broadly viewed, in certain aspects, as seeking to achieve man-machine symbiosis, using computer-based communications and analysis tools to augment human intellect and collaboration. One objective might be to seek to apply the best of human and automated capabilities, with a flexible mix that depends on the task at hand and evolves as capabilities and usage skills co-evolve. Thus, in various embodiments, semi-automated methods may be preferred over fully automated methods, perhaps until automated methods are broadly recognized as achieving a robust level of consistently good results, results in which both false-positive error risks (type I, or alpha error) and false-negative error risks (type II, or beta error) are acceptably low.

Even with such recognition, manual review and action might be maintained on an exception basis. A simple example is in defining threads, which can be purely manual (by the submitters, or by human editors or moderators), automated, or hybrid, and this might be subject to continuing refinement by both human and automated tuning. Techniques introduced in one context or medium might also be extended across other contexts or media, such as for example in the case of superimposing an inferred thread structure on realtime chat, similar to the thread structures used in asynchronous discussion forums.

Another aspect of this rating process is a method to extend the adaptive social decision system and ratings process to the operation of this social decision process itself. As noted above, ratings can be applied to ratings, and to systems of ratings, both explicit and implicit. Just as items are ranked by such methods, the ranking methods themselves can be ranked by such methods, for instance, in terms of whether the resulting distribution of ratings is consistent with independent readings of opinion and behaves in consistent ways to achieve the desire discrimination effects. Much as people can rate movie reviewers and rank them by various specific criteria and overall, social decision rating and ranking methods can themselves be rated and ranked.

Given that a marketplace of this kind can come to have very broad influence affecting many people and allocating significant value, it may be advantageous that the methods used be open to ongoing review, testing, enhancement, and adjustment. By allowing open inclusion of multiple alternative methods for the various rating, weighting, analytic, and visualization tools, and structuring processes, to encourage introduction and trial use of new methods, a flexible, open-ended suite of alternatives can be maintained, and social processes can be used to determine which are used when key social decisions could be made.

For some decisions, such as promoting promising inventions, multiple tools may be used in parallel, while for others, such as for the final allocations of the value assessment and exchange process described below, one best, most trusted tools must be selected and used at any given time. This flexibility might provide for ongoing adaptation of methods to seek a common consensus position that adjusts to advances in methodology and technology, changes in social environment, and other external and internal change. Such diversity and flexibility of processes can be applied within a given marketplace, and in the interplay of multiple cooperating marketplaces.

### Defensive Publication

A further aspect of the adoption marketplace is that it may offer a significant improvement on current defensive publication methods. Such marketplace submissions may serve the basic objective of those who submit to defensive publication, and add the prospect of actually gaining economic value from surplus ideas. Even apart from the economic value, the addition of the collaborative ratings to such publication adds to the recognition value obtained.

Thus one aspect of certain embodiments of the present invention may be to offer defensive publication services that employ ratings and/or compensation terms. Other features may include an option for anonymous publication. Such a dual-purpose publication method could offer a “fire-and-forget” economy in that contributors could turn away and simply ignore any response to their contributions if they so desired. It might be desirable for such participants to set filters that could evaluate any response activity and pass through responses that passed some defined value or activity threshold. Such broader service would also be more supportive of realizing the potential social value of these publications.

### Private Mode and Anonymity

Inventors may be given the option to remove an item from public view, such as if a dialog leads to enhancements that require confidentiality prior to filing, or if a venture develops. The marketplace system could still be used in a private/restricted mode to maintain an audit trail of all dialog and protect the parties. Participants could also be given the option to communicate possible enhancements or offers in private mode. However, such options may be constrained in various ways (including time limits), perhaps to encourage maximum open dialog and participation.

Similarly, as noted above, participants could be permitted to make anonymous submissions. Such usage could be systematically discouraged by the normal workings of the reputation system, in that anonymous participants could be given low reputation, possibly at the same level as that of a new participant who is identified, but as yet unknown in character. That level might still be higher than that of a known participant with negative ratings, such as zero, versus a negative number.

### Inventorship and Assignment

One potential inventorship issue relates to the handling of enhancements that add to inventorship. One approach might be to have marketplace terms provide support processes and suggested business terms for identification of additional inventors and their specific contributions, and for appropriate revenue sharing. Another approach might be to have contributors left with the option of retaining full independence, to independently file patents with claims limited to their own inventive aspects, again possibly with marketplace-maintained records of who contributed what elements.

More generally, inventorship may be an issue in value compensation, in that those who contribute to an invention in ways other than legal inventorship may be found deserving of compensation, whether for specific know-how contributions, or for more process-oriented forms of support in the development and commercialization of an idea, such as promoting an idea, finding applications and partners, and the like. The same social decision methods can be applied to this as well. It will be understood that legal inventorship might normally be expected to be determined by established criteria and methods, and what is addressed with regard to value compensation might include aspects of contribution that may or may not constitute legal inventorship.

It will also be understood that in many cases, inventions may be subject to assignment even in the earliest stages, such as, for example by reason of employment agreements, and also that the processes of idea development provided by the marketplace may continue to be usefully applied to items after a submission that had not been assigned becomes assigned. For simplicity of description, much of the discussion herein is in terms of cases where such assignment is not an issue, and inventor and assignee are one and the same. In cases where a submission involves an assignee other than the inventor, it will be understood that the processes described herein will recognize and distinguish those roles, and that the methods described herein for allocation of recognition, rewards, equity, control, and the like will address those roles individually and accordingly.

Similarly, it will be understood that the processes described herein for assessing and allocating shares of contributions, rewards, equity, and control, both within the marketplace and drawing on external authorities and processes, might be similarly applied to the handling and resolution of any cases where such assignments might be unclear or in dispute. The details of such distinctions and the application of assessment/allocation methods will be apparent to one skilled in the art in light of the teachings herein.

### One-Year Grace Rule and Related Workflow Support

Specific marketplace support features could be helpful to facilitate the exploitation of a one-year grace period to capture patent rights. Facilities could support open disclosure of status, tasks, and events that bear on managing the marketplace process to best exploit the one-year window, across all active and potential players. This could provide the basis for a suite of services that serves as a specialized IPR docketing and workflow system that operates across enterprise boundaries (which could also extend to more general marketplace-related workflow support). To achieve this, information could be available to enable deadline scheduling and assessment of value as it relates to timing and effort including, for example:
the date of first publication, corresponding one-year (or other) deadline(s), and time remaining
what tasks have been done, what remain toward filing
what scale of effort is involved to get to a filing (done and remaining)
what resources are committed, what are needed
what time and complexity to evaluate, do a deal, and file
the status of any pending agreements for the IPR (license/assignment)
whether/when a provisional patent application (or full application) has been filed
availability of inventors/contributors for ongoing development work (time, resources, general terms)
similar information relating to grace periods and filings for any jurisdictions other than US.

Related to this are various factors and metrics to be considered in analysis. Such factors and metrics include, for example:
the intrinsic value of the idea, and how it varies over the one-year window, ranging from newly disclosed to almost at deadline. This might be in terms of an options pricing model that adds these window factors.
the exposure profile of the idea (is it just disclosed, and thus a possible unrecognized find, but lacking review; does it have a strong rating trend; is it stalled with a ticking clock that will soon expire, but possibly available on attractive terms)
the rating profile (the number and level of ratings over time, with what consistency, credibility and confidence)
IPR deals pending or in place

Tools can use this data to assist participants to determine and screen for key factors, and to do their own scheduling. Such tools may also provide for private, user-specific adjustment of such parameters, and use of proprietary metrics, to allow a privately controlled analysis.

One of the general services of the marketplace, and one that could be especially helpful in supporting the one-year window, could be to facilitate fast deals. Providing a default deal structure could allow matches to be made, deals closed, and patents to be filed within the tight constraint of the one-year limit, or a shorter limit if applicable. This might include the use of standard contracts, and might spell out legal and financial terms up front, possibly with the inventor able to post asking rates for flat fees and back-end revenue share, such as for assignment or license.

These might be set as non-negotiable, in which case viewers who wish to obtain rights could be construed to have implicitly agreed, or as a negotiable base, and the stated terms may or may not be binding on the inventor. Knowledge of such pre-negotiation can allow for a quicker deal closure time factor to be applied. Developers wishing to obtain IP could be incented to act rapidly in good faith, since patentability could lapse. The inventor may be exposed to the risk that it does lapse, and that some might act in bad faith to delay until that happens, thus forcing IPR into public domain, and the marketplace could seek to set rules and monitor participants to control such abuse, whether directly or via community-based or external reputation pressure.

Additional support can be applied to assist contributors in putting disclosures into a form that may be readily converted to a patent application. This is essentially the reverse of a feature that would support conversion of a patent application into a technical disclosure—instead the method is to start with a technical disclosure or technical disclosure-like posting and augment it (in stages and with collaborative input) to become a patent application. Again, it might be desirable that such full disclosure remains public, although provision could be made for pulling activity out of the public view when desired by the parties involved.

As confidence in these methods is gained, this support could further take the form of a process for collaborative patent application preparation that automatically and/or semi-automatically determines ownership shares based on respective input/enhancement contributions, defines corresponding IPR ownership agreements, and automatically and/or semi-automatically files patents to meet window deadlines. Such allocations might be imprecise, but satisfactory for low-cost/short-deadline deals.

Similar methods could potentially be adapted for use by the US (or other) Patent Office to aid in patent examination, and could also interact with the open community marketplace systems on issues such as evaluation of prior art.

While this discussion has emphasized the US patent system and its one-year grace period for filing, it will be understood that these methods are applicable to any patent system in which a similar grace period is provided. Such periods may be shorter or longer, such as for example the six-month grace periods currently applicable in some situations in Canada and Japan, and similar support can be included for such differing deadlines, and for handling of multiple such deadlines. These methods also apply to alternative forms of IPR protection that may have similar grace periods, such as German utility models. Note also that many of these workflow and scheduling methods are applicable to support adoption processes more broadly, not only with regard to the one-year patent issue, and can form the basis of a broad-function, cross-enterprise IPR development workflow support system.

### Alternative Value—Shadow Patent System Methods

A motivating factor in the invention adoption marketplace is the potential of delivering value to the inventor and other contributors. Recapping from elsewhere, this can broadly be grouped into the following areas:
Indirect, non-monetary value compensation through recognition internal and external to the marketplace. In many cases, even in basic forms, this alone might be sufficient to motivate contributions, and in a well-developed social context, indirect access to direct value, such as mass-market publicity can be very valuable.
Direct monetary value compensation through the patent system, through exploitation of the one-year grace period as described above, and otherwise, in ways that can be supported by the marketplace community
Alternative direct monetary value compensation systems along the lines described above.
Alternative systems may also involve non-monetary value, aside from pure recognition and access to other rewards, such as in the form of other systems of credits or tokens that can be exchanged.

Some issues in alternative systems will now be further addressed.

One aspect is whether a mechanism can succeed in offering financial rewards to inventors outside the current patent system and/or outside other existing IPR protection practices, such as copyright and trade secrets. This could be applicable because the one-year window has closed, but it may also be desirable to reward inventors that might not qualify for a patent, but may have made a meaningful contribution.

Contractual obligations among marketplace system participants might be one way to accomplish this, with associated legal enforcement methods. A variety of specific contractual structures and enforcement methods may be considered. A minimal step may be a simple agreement that simply commits members to respecting the IP rights of all participants. Should a requirement of a tighter commitment legally compromise the ability of publication within the system to qualify as prior publication for patent purposes, such commitments might be time limited. This could permit a short period of protected publication, and possibly focus attention during that period as a first, early look to a limited community, then flow to a more completely open publication. Some further points regarding a contract-based structure for value compensation will now be discussed.

In certain embodiments, the marketplace might provide for secondary agreement terms to be binding on viewers to ensure compensation for use of an idea even without any patent, unless it can be shown as invalid on the basis of defined non-patentability or other criteria, possibly with resort to litigation or arbitration in the event of disputes. Thus some form of private, limited, patent-like protection could be provided by contract. Such methods might naturally not constrain outsiders to the marketplace who learned of the invention and exploited it. This might prove workable, for example, if the early access offered by the marketplace was seen as sufficiently valuable to warrant the cost of agreeing to such a constraint, or if external social pressure could be applied to outsiders as described below. Furthermore, terms could also define when the idea enters public domain with no marketplace agreement restrictions, and/or with restrictions that only assure recognition of the original source, with no requirement for other compensation.

In structuring participation agreements, it might be desirable to provide for multiple levels of participation, perhaps with correspondingly varying privileges and obligations. As noted above this might provide for limited, preferred access to defined classes of items (or for defined initial access window periods) to full or higher level participants, and lesser access to limited participants. Similarly, fuller participants may have more strictly defined obligations regarding non-disclosure of items to lower level or non-participants, use of items, and compensation for use of items or other value exchanges. Such levels might further vary with regard to domain, role, and other conditions.

Given that there may be issues of practicality and acceptance with regard to a contract-based system, it is important to note that the publicity value of the marketplace system might be exploited to enable a more voluntary form of shadow system to be used. A recognized and fair method of bringing public recognition of equity in using ideas offered through the system could be very effective, particularly if the community becomes large and gains respect. Some applicable methods could be the use of processes that attract public recognition and that are demonstrably fair, to a reasonable extent, in identifying the following:
Ideas sources and relative contributions of participants (such as through the community mechanisms described)
Application products/services/uses that exploit those ideas (such as through a parallel community process of evaluation, and possible support from a small staff of experts)
The relative value contribution of the ideas to the products/services/uses (such as similar community processes, and possible support from a small staff of experts)
A level of inventor “royalty” that may be viewed as fair to inventors and not unduly burdensome to exploiters (such as through similar methods, and market forces). This might perhaps more properly be viewed as a pseudo-royalty or phantom royalty (analogous to phantom stock).

Market forces combined with visibility to the public could support a method that works much like a patent pool, with royalties from exploiters in proportion to their use as measured by some defined criteria, and to contributors in proportion to their input. The fee to exploiters might need to be small relative to the value of participating in this source of ideas to encourage maximum participation and compliance. This could limit the rewards, but even a relatively modest rate of reward might have significant value in incentivizing invention and the aggregate value might be very large. It may be a case of taking a small slice of an enlarged pie.

Those who participate in the community might be obliged to pay their “dues” in the form of such compensation, and might be subject to a high level of public pressure if they cheat. Those who do not participate but expropriate the ideas beyond minimal levels could also be identified and subject to internal and external public pressure through bad publicity. Transparent and open evaluation processes and results can allow for contributors and exploiters to contest preliminary findings, and the public to judge their fairness. The system can evolve and improve as flaws are found, and improved methods are developed.

The task of establishing such a voluntary shadow system could be difficult if done without proper groundwork, but by first having the marketplace community establish critical mass based on the real patent and non-cash rewards alone, then this shadow system might be developed with some real clout. Note that the monopoly right of patents might be hard to establish under such a shadow system, but it might be judged that such monopolies are only desirable to the extent provided by the regular patent system. The intent here might be more one of compensation for use that is otherwise unrestricted, than one of monopoly.

As a variation on shadow royalty allocations based on direct estimates of idea contribution of shadow patents to a product/service/use, surrogate measures could be used, such as charging some percentage of the real patent fees that are also associated with the product/service. Simple schemes might simply assess flat fees for broad classes of applications, and to the extent that the fees are judged not onerous, more precise value assessments may not be required. Companies that contribute inventions through the marketplace might also be granted special credits/discounts on royalties owing that might be commensurate with those contributions, perhaps in addition to any monetary rewards they generate.

The allocation of payout to specific inventors can also evolve as methods improve, starting with a simple model of equal shares to all who have a demonstrable input to a product service, or even all who contribute any ideas or all with ideas that rate above a given threshold, to complex weightings of idea value and relevance contribution. Rewards might also go to those who merely add collaboration value, based on ratings of that value.

One principle may be that the marketplace seeks to find value compensation methods that produce a market-style value transfer that approximates what might occur in a full market exchange, and apply it in situations where actually conducting all of the implied market transactions may be impractical. The compensation process could work by using a select group that can act as a proxy for the broader economy, assessing the value proposition of buyers and sellers, contributors and users, throughout this development/use life cycle, as discussed further below. Thus it might be used as an interpolation method, one that must be calibrated to external, real market valuations and processes where such external markets are operative, but can be used to estimate values both before such markets are operative, and in fine-grained sub-allocations in which market mechanisms might be impractical, such as because of transaction costs or thinness of the market.

This may be important in rewarding many contributors who deserve small shares of value that are not practically addressed by conventional market trading and IPR ownership processes, and extending those processes to encourage contributions. The market surrogate value exchange objective might be to each according to their contribution, and from each according to the value obtained. Copyright clearinghouse services like BMI and ASCAP provide a somewhat related mechanism for music creators and users in a situation where individual transaction negotiation is typically infeasible, but are limited to using the simplest of flat-rate schemes (which may satisfice for such microtransactions). The methods of collaborative support systems, applied as described here, provide a way to do a far more refined allocation that may be more reflective of the true value exchange, while maintaining protections against fraudulent abuse. It will be apparent to one skilled in the art that these methods are applicable to other domains, such as copyright rights management needs.

### Methods for Allocation of Equity and Control

An issue that runs through various embodiments is the need to allocate value, and to similarly allocate control of development and commercialization. These two aspects are broadly similar, but not identical, and may involve somewhat different issues and methods. An inventor or contributor may be motivated at least in part by an expectation of value, which may often be the primary factor, but an important secondary factor, which might actually dominate, is the issue of control. As noted above, this discussion refers to “inventors” or “inventors and other contributors” for simplicity. In cases of inventions that have been assigned or are committed to be assigned, it will be understood that this allocation of value and control might relate to assignees and/or to some allocated and/or specified combination of inventor and assignee. Similarly, it will be understood that these methods might include consideration of distinctions between personal and organizational roles as appropriate.

As outlined above, the value to be delivered to inventors and other contributors by an effective marketplace system includes at least three categories: Non-monetary recognition and collaboration value, monetary value obtained through the formal patent system, and monetary or other value obtained through alternative “shadow patent” systems. The control that inventors or assignees or others may exert can occur at a variety of levels, including control of patent prosecution and resulting patent rights, such as to license or assign, and other aspects of control, such as in direction and stewardship of marketplace-supported collaboration processes relating to development and use of an invention, including those that may be unrelated to any formal patent rights that may or may not exist.

One objective of the marketplace may be to ensure that contributions are rewarded equitably, so that all who contribute can expect and receive their fair share of any rewards. This share might be expressed as a share of proceeds, and thus might be essentially a financial equity stake, whether in the strict form of corporate equity, or some more specific surrogate, such as phantom shares or limited interests, such as simple shares of net proceeds. Such stakes may be by contract or implicit agreement.

At the same time, inventors and other contributors may seek to maintain control of the use and development of their ideas, and of any enterprise that may have patent rights. This may simply be for personal emotional reasons of ego satisfaction and sense of ownership, but may also be for socially oriented and rational reasons that may be in society's interest, in that they may know best how to develop the idea, may potentially be its greatest and most dedicated champions, and may be most deserving of stewardship of the idea for the public good. Conversely, it may be that the original inventor is not capable of effectively stewarding the invention, and therefore there may be a social interest in having that responsibility placed elsewhere, for both the overall good, and the ultimate reward to the inventor.

The two factors just noted may interact, with good handling of both issues maximizing both motivation of inventors and key contributors, and the realization of beneficial advancements.

The mix of traditional methods and emerging CSS methods described above can be applied to these specific issues. One exemplary embodiment is expanded on to clarify some of the issues noted above with regard to patent ownership and control, and the deal terms that might be favored within the marketplace community. These issues address the rights and obligations of contributors who may be considered inventors, or who may have other valid claim to compensation for developing a concept.

According to a simple base approach, all rights could be left with individual inventors and contributors, with each entitled to file patents based on their own contributions. Each could potentially file separately, possibly resulting in fragmentation and weakening of the IPR, or they might independently forge agreements with collaborators to work together on joint filings. Collaboration tools could be provided to facilitate negotiation of such agreements. Such an approach might be simple in terms of demands on the marketplace, instead placing responsibility with contributors, but might not be optimal for certain applications.

An alternative approach could routinely move all or most of this determination to CSS processes driven by the marketplace community, or a combination of such communities, including multiple cooperating communities, and/or external processes. This could take the form of complete reliance on the alternative value allocation processes described above, applied both to equity shares and to control authority, with marketplace agreements in which the participants cede the necessary authority to the community process. The effectiveness of such an approach might depend on the extent to which decision processes are well developed, both as to methodology and acceptance.

An attractive intermediate approach might offer a combination of simple formulaic agreements with some bounded use of CSS processes. A general strategy could be to provide set formulas and systems of rules that can be seen to bound the results to a range that might likely be acceptable, and yet leave some tuning of specific allocations and control transfer points to be decided based on CSS methods intended to adapt to the exact results with those bounds to the merits of a specific situation. This could have the benefit of relieving much of the burden of negotiation, with uncertain outcomes, time delays, and potentially high transaction costs in time and emotion, while still providing some confidence of equitable and acceptable results. This might provide a method that can be relied on as “good enough” to allow participants to focus on the work of advancing ideas, and not get tangled in equity and control issues except in unusual and infrequent situations. This benefits from structures that are constrained, predictable, and transparent, and which can generally run without attention, except at discrete checkpoints where review and action can be taken if things go awry.

A particular method of this kind, explained in terms of use with the legal patent system, but applicable more generally, will now be presented.

First, one of its possible features may be a basic ground rule of temporarily revocable submission to the community process. Inventors and contributors could agree to submit contributions to be handled in accord with the defined community process, contingent on further agreements. The basic process may be that original submitters of an invention start with full equity and control, but that either or both may be diluted as others contribute. Further agreement might be required before such dilution would be formalized

Until a further commitment is made, the inventor might retain the legal right to withdraw if those processes produce a result they refuse to accept. CSS reputation management processes might come in to play here to balance this option. Inventors could understand that such withdrawal might be legal, but costly to their reputation in the marketplace—(e.g., that collaboration and recognition of future contributions may be significantly discouraged if they have a reputation for reneging on this compact.) At the same time, the protective “bail-out” option could encourage contributors to more readily “buy-in” and take a chance on a system they might not fully trust. This could offer a reasonable balance between the value promised by the community and the alternative of going it alone.

The same or similar reputation management systems could apply to all others involved in the community process, and any abuse of the CSS processes could put those parties' reputations at risk. A disgruntled party, such as an inventor, may pursue various protest methods that can put other parties reputations in question, again applying the CSS methods to seek valid assessments. Such protests may occur while working within the system, or in defending the validity of a renege action by protesting the decisions that led to it, thus possibly defending their own reputation.

As alluded to above, the management of equity shares in compensation can then occur within that revocable context. For instance, as indicated, the initial status of a “new” contribution may be that the submitter may be the sole equity owner. One alternative that could be supported by marketplace agreements could stipulate that this is to be retained, and that any contributors automatically assign their interest in any contributions to the original inventor, but such a practice may dissuade many potential contributors.

An alternative that could also be supported, and that may be expected to be more supportive of community participation, could be to agree that if additional contributions become significant to the development of the idea, equity shares may be split among contributors. A defined process could state when and how the decision process operates, and that its result may be presented to the current equity owner for acceptance, with various procedures for appeal, and potentially with the ultimate option of withdrawal. Once an initial dilution is accepted, further dilutions might or might not be subject to similar approvals.

It is further noted that the specific process of equity allocation may apply a variety of methods based on CSS processes within the community and externally, with various algorithms. One method may be to combine a mixture both of model-based rules that are driven by factual inputs, and of weighted voting to address judgment issues. Simple examples of model-based rules could be used to set bounds, such that an original inventor may not be diluted below predefined levels and corresponding to predefined circumstances, and some of these rules may be moderated by voting processes, and some not.

The voting processes may be confined to work within these limiting parameters, and may be governed by weightings, such that voters get weights based on their position in regard to a contribution (as in higher weight to a contribution owner, and also to other early contributors), and weights based on their reputation. Thus for example, a scheme may delineate tiered ranges of equity share, for initial inventors and for each of specific numbers of additional participants making either inventive or other contributions, possibly with factors to favor earlier contributions, relevant aspects of reputation, and the like. The CSS voting processes may then be used to select the specific shares within those ranges warranted in each particular case.

With regard to control, similar processes may be applied. As before, gain, the initial status for a “new” contribution may be that the submitter has full control. This might be important, for example, in that it may be less practical to dilute control as additional contributions are made than it may be to dilute equity share, particularly perhaps given any limits of community processes as applied to the urgency and special demands of executive action. Thus delineation and adjustment of control may take forms quite different from equity share.

Another control method might be to treat the original contributor as maintaining control, with a responsibility as steward for the invention, as long as there is no substantial basis to judge that stewardship as failing. Once there is evidence of the inventor not being up to the task and “dropping the ball,” the community may then seek to find one or more participants to work as a body that seems most likely to achieve the latent value, such as based on their reputation and demonstrable experience. This stewardship could remain distinct from the equity. The original contributor may retain a large equity share, but lose some or all control, and this may be further delineated to provide for different limits of control for different classes of decisions, in a structure similar to the formal limits of authority structures sometimes used in large organizations.

Again, rules may define the boundaries for such control transfer actions, with CSS processes adjusting within those boundaries, and with a series of dispute resolution methods that may draw on internal and external processes. And again, a mix of decision rules and weighting systems that bound CSS processes may apply.

For example, original and early contributors may have extra weight intended to favor their retention of control, and all equity share holders may be favored over other participants who have no vested stake (but who may have a prospective social interest and who may have other kinds of authority, including the case of participants given a special marketplace steward role). Again, the ability of marketplace processes to alter control in this manner may be relatively constrained with regard to any formal patent rights that may derive, which inventors might retain under the terms of the marketplace agreements, but more flexible with regard to the alternative processes described herein, in which inventors might be expected to yield greater latitude to the marketplace processes, in return for participation in the marketplace value compensation systems.

Similarly, subsequent further changes of control may be provided for, again based on specified conditions and CSS processes. This method could be structured to seek to ensure that the original contributor has the chance to take his or her idea all the way, and loses that chance only when he or she is judged to be stumbling. This too might be a good compromise to encourage participation at an acceptable level of risk. Here too, a right to withdraw and retain full control of patent rights may still be operative, or a stage may have been reached where that right was formally ceded.

Various methods may be built into these decision processes to seek results that are fair and productive. One method may be to structure the processes to treat equity share versus control as representing the past versus the future. Equity share may be considered as potential value compensation for contributions made, delivered, and irrevocable, but perhaps subject to dilution, as other contributions are made. This may be the reward primarily for teachings given to society, and secondarily for the development of those teachings to realize their value. Control, on the other hand, may be considered as forward-looking, as trust to provide stewardship of the invention, to nurture and ensure its future development and application.

On this basis, stewardship may be a trust that may be revocable, based on the interests of society. Similarly, control might not itself warrant equity share as a reward for future value contribution that is not yet delivered, and such compensation might reasonably be contingent on actual results obtained. Thus on a change in control, some equity share might be offered as potential compensation, contingent on meeting defined objectives or revocable on failing to meet milestone deliverables.

The CSS processes used in such determinations may be understood as operating at a range of levels: within sub-communities, within a specific marketplace community as a whole, within a confederation of such communities, and interacting with external decision processes and dispute resolution mechanisms. CSS voting processes may involve multiple sub-communities, including those directly contributing to in the invention, those with other forms of direct involvement, a panel of domain experts, a specialized arbitration panel, and the like, as well as the open community. As noted, voting may be weighted by involvement in an idea, by expertise and formal qualifications, reputation, and other factors.

External dispute resolution methods may include the patent system, court systems, arbitration bodies such as the American Arbitration Association, and the like. It might also be desirable that the marketplace community include its own dispute resolution bodies, structured for expertise in issues and subject domains, some of which might have ongoing roles as virtual boards of advisors or directors. For all of these, the CSS facilities of the marketplace could offer decision augmentation tools that assist in providing all with objective, full, and clear understanding of the issues. It is also important to keep in mind that in arbitration among involved parties, the marketplace reputation management processes seek to ensure fairness. For those who participate in decision processes who are not direct parties, these processes also provide some indirect compensation in the form of reputation gain opportunities, as well as opportunities to gain entre into the teams collaborating on a development, which might lead in turn to other opportunities as a networking activity.

The kind of structure just proposed can be structured to achieve a number of key objectives. It can be relatively simple to support and administer, and transparent in operation, thus encouraging participation and avoiding draining business distractions. While is may be that a highly developed marketplace system could get very complex in its operation and support, much simpler embodiments may suffice, especially in initial embodiments. The objective may be to be “low maintenance”—to be “good enough” to encourage participants to rely on it, with some confidence that it can be expected work within understood and reasonable bounds, and that it could seek to achieve a reasonable degree of situation-specific fairness within those bounds. It could also work with the bail-out provisions that provide protection against serious failures. The possibility that use of that protection might be an undesirable last resort could provide a balance of protection on both sides.

This method of “satisficing” (sufficing at satisfaction of an objective) might be particularly well suited to a possible objective of the adoption marketplace to serve the low and middle end of ideas. It may be clearly sufficient for “throw-away” ideas that might otherwise be lost and offer a reasonable value proposition for middle-range ideas.

With regard to the difference between low and middle range ideas, the rules described above may be tiered with regard to level of value. Rules may have different effects and/or different levels of complexity for different levels of value, both estimated and actual. Equity shares may be tiered, so that original and early contributors have high shares up to some level of net and/or gross return, with other contributors participating more fully beyond those levels. Control rules may vary with estimated value, where inventors may be given more latitude to retain control of a low value idea, where the value to society of ensuring stewardship may be not great, but less latitude for ideas judged highly valuable. Naturally lower level ideas submitted for adoption may turn out to be very valuable indeed.

It should also be understood that the distinction between a new original invention and a collaborative contribution to another invention may be flexibly defined and situation dependent. Thus a participant may have some discretion as to whether a contribution is submitted as free standing, or as an enhancement (which might also relate to how patent claims could be written), and similar flexibility in the application of the methods described here may be provided. For example, a participant could avoid issues of shared ownership and control by electing to treat a submission as independent.

However, one of the objectives of certain embodiments of the marketplace and its CSS processes may be to make collaboration powerful and attractive to contributors (perhaps as a way to maximize value to contributors) and to society (perhaps with a synergistic whole being far more valuable than the sum of the parts). This relies on the effectiveness of the collaboration tools and the creative communities it provides, the results that are seen to be delivered, and on the perceived fairness and trust in its reputation, equity, and control processes. As such processes become well developed and proven in practice, participants may increasingly trust collaboration as a way to leverage their contributions, and may increasingly be willing to yield some equity and control in the expectation of greater reward, both direct and indirect.

While this section addressed the issues of equity and control with emphasis on the example of the conventional patent system, it is apparent that these methods apply equally, with only minor adaptation, to alternative value or shadow patent systems as well.

### Revenue Models

Various models could be applied to funding the marketplace and generating profits from its operation. Exemplary models include:
Revenue share (or flat or tiered fees) in license/assignment deals between members
Poster and viewer fees (based on usage and/or simple membership fees)
Sponsorship, such as by IPR oriented companies and support services who might benefit from the exposure and association
Advertising, such as by IPR or other technology and business services-related companies
Non-profit charitable and government contributions (supportive of the contribution of the marketplace to the public good)
Equity or phantom equity share interest in alternative value systems
Other methods.

Revenue share in deals might vary based on the level of value-add provided by the marketplace, such as with lower levels for simple buyer-seller matching, but higher levels for substantive collaborative development that was facilitated by the marketplace community systems. Poster and viewer fees or membership charges might vary based on role.

As another example, it might be desirable to keep any fees to individual inventor and development contributors at very nominal levels to maximize membership and possibly to just assess some minimal fee to discourage frivolous or abusive activity. For example, a small posting fee might discourage spam. On the other hand, participants who use or apply inventions, or who derive business revenue from services to the community members, might be charged higher fees. As with many of these revenue alternatives that can substitute for one another, generic usage and membership fees can potentially be used as a rough surrogate for transaction fees or phantom royalties. The general trade-off of simplicity of a charging or pricing method versus its perceived equity and effect on economic behavior may present a challenge, and a wide variety of solution mixtures can be applied and adapted, based on specific needs and cases, possibly using tiered structures.

The marketplace might also benefit directly from publicity relating to its potentially significant contribution to general welfare. In addition to direct revenue models, it might be justified as a non-profit, subject to grants by charity or by government funding. It could offer a significant contribution of valuable ideas that might be lost to society, and its mechanisms could extend the rewards for ideas back to all contributors on an egalitarian basis that compensates for lack of resources or other position power, and makes resources and position power accessible to all who contribute good ideas.

In addition to the roles as a pure intermediary and support service, the marketplace might take direct interests in some or all of the ideas submitted. The interests could apply to transactions made internally or externally to the marketplace. In cases where an invention becomes patented, the marketplace might share in any license or assignment revenues. In cases where the alternative value shadow patent systems applied, the marketplace might also have a share. The applicability and size of such shares might be dependent on the contribution of marketplace members, and of marketplace processes, relative to that of the original inventor.

The marketplace might further take on IPR for its own account, acting as a foster home as well as adoption agency. In such cases it might provide resources and support for patent application and prosecution and for development and commercialization, in return for a more significant share of any value obtained. In this role the marketplace might act in ways similar to those of an IPR commercialization firm.

Rules might be established to limit such direct dealing to be secondary to open market third-party deals with other participants, such as possibly limited to cases where no acceptable or timely third party deals can be accomplished, and policies might be applied to ensure that no conflict of interest between the marketplace and its members can develop from this dealing role. In order to encourage contributions, perhaps especially to attract contributors who are sympathetic to the philosophy of the open source software movement, policies might be established to ensure reasonable and non-discriminatory licensing terms, and possibly further to provide for free licensing of technologies for certain classes of use, including for example use as parts of standards.

Certain embodiments might involve special joint venture or partnership relationships between the marketplace and one or more third-party commercialization firms. The value proposition here may be that the marketplace provides sourcing and basic facilitation and support services, while the commercialization firm provides funding and deeper development and commercialization services. In this role, such commercialization firms might act as just another class of participant with this special dealmaking and financing role. Such partnerships with commercialization firms might add significantly to the ability of the marketplace to attract and deliver value to idea contributors, and this is an example of the kind of multi-level combination of internal and external sub-communities that can be exploited by an open marketplace system.

### Universality, Market Ecologies, Balance, and Advanced Social Processes

There are advantages of entrepreneurial diversity and innovation in having multiple competitive marketplaces of this kind. However there are also significant benefits of scope and scale in having a single place to post and search for ideas. A compromise may be to have independently operated marketplaces, which may have varying policies, but with global interconnections that provide common services to allow for global searching, multiple posting, cross community collaboration, and other features that give much of the effect of a single global marketplace that may be a composite of multiple sub-communities. This may bear some similarity to the global financial markets, where participants can trade in multiple markets concurrently. Such loosely collaborating and confederated but largely independent structures can also provide valuable diversity of methods and results, thus ensuring flexibility and allowing problematic effects to be circumvented.

The structure of the marketplace community can take on very rich forms of ecology, institutions, and economy, both regarding sub-communities within a given marketplace, and across marketplaces. Sub-communities relating to common roles can form to interact with one another, and with other participants, such as sub-communities of inventors, developers, commercializers, consultants, investors/financiers, publicists/press, and the like, some of which are addressed further in other sections. Such interactions may involve direct monetary compensation in some cases, or may be factored into the alternative value exchange processes of the marketplace.

As noted elsewhere, this ecology may also apply to the interworking of the marketplace community with other similar marketplaces and other kinds of communities. This may be described, for example, in terms of interacting communities of practice, in which specialty sub-communities having complementary roles interact with one another, and cross-cutting networks of practice, in which sub-communities having similar roles in different contexts, such as different domains or geographic regions, share information and insights.

One area of such possible interconnection relates to enterprise systems. Networks of practice within an idea marketplace relating to needs and inventions in specific application domains and possibly relating to specific products or product classes could also interface with enterprise-based collaborative product development systems or other knowledge systems, possibly forming intersecting hybrid public and private communities, acting as a form of extranet with boundaries that vary in permeability depending on the task and content, possibly governed by a hybrid of automated and manual security rules and privileges.

Such connections could enable new forms of cooperation between enterprise R&D and product development groups, not only with customer enterprise-specific communities, but also with open public communities like the idea adoption marketplaces. Such interactions could possibly produce revenue to the adoption marketplace in return, perhaps, for specific IPR and usage rights, or more broadly as a fee for collaborative market insight and creative services. Similar interaction with enterprise systems could relate to IPR management within enterprises that is selectively opened to the outside public community to support two way interaction on those technologies that an enterprise wished to expose for development or trading, once again including very early stage ideas. Other such interactions may relate to patent systems, other government and regulatory systems, technical, professional, and trade associations, consumer associations, and the like. Technical methods for such interworking are as described above.

Pursuing these methods to widespread implementation, the use of a shadow patent system might in advanced stages take on an importance of a quasi-governmental body—as might be the case for other advanced electronic communities as well. Social decision processes could potentially take on all of the complexity and concerns for abuse of governments, and ultimately, government might evolve into a CSS. Clearly protections and checks and balances might be needed to ensure justice, just as in conventional governance processes. Key concerns are control by individuals or small groups lacking well-founded authority, and by democratic methods run amok in a tyranny of the majority. Controls to address these issues may take a number of forms, and may be very analogous to current practices such as those provided in the US Constitution and similar structures.

Checks and balances could provide for multiple bodies with distinct responsibilities, such as executive, legislative, and judicial, and could draw on representatives to oversee critical decisions and methods. Such representatives may be elected by democratic methods, or through reputation-based methods, or some combination. Expert panels could also have key roles, again, possibly given limited charters and oversight by elected representatives to avoid abuse by a technocracy. External communities and governmental bodies may also have oversight roles in order to ensure broadly based input and sensitivity to the overall welfare. The use of multiple confederated and cooperative marketplaces, as described above, may also provide a level of checks and balances as well.

### Graded Openness of Sub-Communities

The use of CSS methods that draw on ratings, reputation, and authority can provide highly flexible and adaptive methods for determining what participant items are considered, with what prominence, for any given issue and at any given stage in a collaborative process. This might fundamentally balance the conflict between efficient focus and flexible openness.

Traditional collaborative processes that lack such systems tend to use relatively rigid methods of qualifying participation and shutting out noise in order to maintain focus and progress to meaningful results. Important evaluations and problem solving sessions are typically conducted within closed sub-communities, such as enterprises, joint ventures, trade groups, technical societies, defined standards bodies, government agencies, academic institutions and the like, and sub-units within them.

Even relatively ad hoc bodies, such as special committees, have discrete boundaries and life-spans, and may adapt only at a limited pace. External ideas and opinions must often be introduced, literally “brought in,” by a member of such a responsible sub-community to be considered by such a body. No amount of external consensus can force an outside idea into consideration until at least one insider agrees to put it before the group. Such introduction may also involve a quantum leap of attention, in that low levels of attention by many insiders may not be sufficient to introduce an idea or position until it reaches some gradient threshold level of attention with one member. These boundaries, thresholds, and needs for sponsorship tend to limit the attention of such closed bodies to new and different ideas, no matter how receptive and flexible they may try to be.

The reputation methods described here might eliminate this rigid hurdle while still limiting the noise of masses of unfiltered submissions. Instead of rigid, quantum boundaries, the process can be highly fluid and ad hoc. Reputation weighting can give the effect of selective sub-communities while allowing for greater permeability in their boundaries. Depending on the gradients and skew factors applied to a given decision or problem solving process and related information visualization tools, a filter can largely restrict attention to insiders, or allow high or low levels of outside ideas to penetrate.

An idea may penetrate because a few highly regarded outsiders rate it highly, because many less eminent but still reputable outsiders rate it highly, or because even though all insiders rate it too low to cross their individual thresholds for formal introduction, some critical mass of those insiders see some sufficient level of merit in it to pass a filter. Conversely, the same methods can more than compensate for this added source of input by also filtering and ranking insider-sanctioned items more effectively. The ability to continually assess and reassess value judgments over a more or less continuously variable scale, and to make the results visible with corresponding levels of prominence, can cause items that are widely but weakly supported by insiders to be exposed as lacking in perceived value, or simply reduced in priority to fall off the active agenda.

Those gradients and skew factors can be flexibly tuned at multiple levels, and defined in terms of multiple, varying criteria dimension, to provide for an infrastructure that has desired behaviors for different kinds of tasks and sub-communities, but may be still dynamically adaptable to changing situations and re-evaluations. These factors can also adapt to balance varying community sizes and activity levels, so that weightings of outsider activity are not unduly sensitive to sheer numbers in cases of relatively higher or lower outside participation.

The methods may be recursively applied, in that the methods of the CSS rating and reputation filtering process can be themselves subject to the rating and reputation filtering process, both as to how items are rated and which raters are given weight. Such methods might require refinement of algorithms and an extended process of validation before they might be widely trusted for important decisions, but by starting with low value, non-critical issues, they can be expected to develop in soundness and in increasingly broad acceptance. This can give the effect of a moderator function, where the moderator determines what gets presented with what level of prominence. As with the other CSS methods discussed herein, such moderation methods might be accomplished by a flexible and symbiotic mixture of automated and human action.

Special support can be included to further ensure that contrarian and novel positions are not undesirably neglected under the weight of conventional opinion. One such method could seek alternative voices as follows. A method of using ratings may be by adapting collaborative filtering methods to seek to find subsets of participants that rate a given item highly. Those subsets can then be further analyzed and can be mutually alerted to this shared position, thus providing a catalyst for further development and promotion of that item. In the case of an item that is generally rated badly, such pockets of support might still be found, and cultivation of such contrarian groups can provide a valuable service for testing conventional wisdom. The rating and reputation systems add value here by identifying cases where these contrarian groups contain members who are highly regarded, for example, either on a broad basis, or for a few good calls, giving the effect of a cross-cutting interaction filter.

Presentation methods might be designed to give selected contrarian positions a prominent secondary placement in reports that highlight the dominant position, as a way to encourage due consideration of alternative views. Similarly, concept clustering and mapping methods could combine with collaborative filtering methods to define sub-groups having specific unconventional or alternative viewpoints. These subgroups could then selectively apply separation filters to protect their internal synergy, and interaction filters to trigger cross-fertilization and creative dissonance. Procedures for allocating items to duty reviewers could also be adapted to seek reviewers likely to be sympathetic, using similar methods.

Thus these methods can be highly adaptable to the needs of an idea adoption marketplace. They can provide an environment in which new and unconventional ideas can be submitted, evaluated by any who wish, and then given attention as their merit warrants, drawing on the best judgment of the largest possible set of participants, and overcoming conventions and inertia by amplifying the insights of the few, subject to the review by the many, while still minimizing the tyranny of the majority.

### Development Process Lifecycle Support

The feedback cycles of idea development can be augmented both at specific stages in the lifecycle, as described in other sections, and across the entire lifecycle. By operating consistently across the entire lifecycle, the establishment of both a continuing community of participants, and a continuing community process to support those participants can have a powerfully cumulative facilitating effect.

One exemplary way to view this life cycle, which may serve to exemplify how these processes can be applied consistently across all of the stages of the life cycle, and how one stage feeds forward and draws from the others will now be described.

A first exemplary stage may be a “need and opportunity identification” stage. It is expected that in any relevant subset of society, all concerned parties can react to the current situation and identify needs, whether present or forward looking CSS methods could be used to collect and organize such needs in terms of value and apparent feasibility. It should be noted that the browsing of such a consolidated and organized set of need statements could itself be a powerful catalyst for invention.

A second exemplary stage may be an “inventive spark” stage. Whether catalyzed by externally driven perceptions of need and opportunity, or in reaction to the community need identification process, contributors can articulate and submit new ideas. CSS methods could organize such submissions by domain and context, and with supporting information on the reputation of the submitter, and the submitter's own positioning and assessment of it. Here again, review of such ideas may catalyze further ideas.

A third exemplary stage may be an “assessment and recognition” stage. Core assessment processes could seek to ensure some level of initial review, and appropriate levels of further attention and assessment. CSS methods could drive this process.

A fourth exemplary stage may be a “nurture and development” stage. Focused attention could encourage further contributions to feed and shape development. CSS methods could drive this, with rich support for the collaborative, multidisciplinary work that may be essential to full development of an invention.

A fifth exemplary stage may be an “application and use” stage. The community could itself organize to deliver some applications of new ideas, such as in pilot tests and test marketing, could support placement and technology transfer with private enterprise, and could act as an influential core group in guiding use and in identifying further issues and needs, acting as early adopters, enthusiasts, and expert users. The CSS processes could support this ongoing critical review of usage. This stage may then feed back to the “need and opportunity identification” stage for further development.

A sixth exemplary stage may be a “compensation” stage. While most obviously tied to the use stage, the compensation process might feed back through all stages to motivate contributions and assess the value received and owed, in a way that is consistent with its functions as an economic system. The CSS process can control the flow of compensation, including recognition, patent participation, and alternative value systems.

By providing a continuing support infrastructure throughout this ongoing life cycle, the idea marketplace system can maximize the power of this feedback process over time, and in drawing out and benefiting from individual contributions at each stage. The specific levels of participation of different community members having different roles might vary from stage to stage, but by having this overall universality, powerful network effects are achieved and costly disconnects are avoided.

### Market Reach and Handling of Low-End/Early-Stage Ideas

As noted earlier, a feature of the methods described herein is the ability to facilitate the nurture and development of early-stage ideas from a broad population, thus capturing a huge store of potential value that is currently being lost.

An aspect of various embodiments is the finessing of the conflict between open development of ideas and protection of IPR, to find new compromise solutions that offer some of the protection of patents along with the ability to forego secrecy and obtain open dialog at the very earliest stages. Such embodiments may act to break through the existing culture of secrecy and paranoia and foster a new open exchange to nurture valuable ideas. More specifically, various embodiments may act to target a previously unrecognized sweet spot: those ideas that seem promising, but where conventional methods of development are too costly, risky, or otherwise unavailable to the idea creator. Included may be cases where an inventor lacks resources and cases where the idea is of speculative value. Thus it could apply not only to many individual inventors, but also to institutions for salvage of the many ideas they cannot effectively develop themselves or within their known, closed community of trading partners.

The value of various embodiments the adoption marketplace extends beyond the ideas that lack resourceful supporters, as has been discussed above, to include a large number of ideas that are never seriously considered as ideas for development at all. Many bright people have good ideas, but are unfamiliar with patents, R&D, and related processes, and simply drop ideas for lack of awareness of how and why to pursue them. Establishing an adoption marketplace, publicizing it, and making it usable and valuable even for novices, could enable any intelligent person with an idea to disclose it, with a realistic supposition that they might possibly gain profit or recognition for doing so if it can be found has merit. With the conventional methods of IP development, most people rightly assume they have no practical way to take an idea further or even find an audience for it without great effort, and thus do not entertain any thought of pursuing their ideas.

From at least one point of view, an inventor may face three kinds of hurdles for developing new ideas, and embodiments of the adoption marketplace provide ways to address them.

The first such hurdle may be an intrinsic one: “is the idea a good one (useful, novel, etc.)?” A marketplace of the present invention may seek to overcome this hurdle through testing. The testing can be accomplished by collaborative rating methods, as described before. This could enable ideas to be assessed, enhanced, and noticed based on nothing more than a well-stated submission.

The second such hurdle may be an extrinsic one: “can I do anything with it (do I have access to the resources)?” A marketplace of the present invention may seek to overcome this hurdle through support. The support may be provided by the marketplace for supporters that the service creates (for fee, equity, or other compensation), as well as by simple collaboration by the community (possibly without compensation except in the form of recognition). This could enable even those with minimal resources to hope for some financial and non-financial reward.

The third such hurdle may be a minimalistic one: “do I play the game and even consider developing an idea?” A marketplace of the present invention may seek to overcome this hurdle through awakening. Success of the marketplace for the above-noted extrinsic and intrinsic hurdles could be publicized to attract new participants, and self-help tutorial material and/or human support might be provided to help make those contributions useful. This could make it known that profiting from ideas is easy enough to be a realistic possibility that should be pursued by anyone with a good idea.

Public relations, publicity, and exposure may be important components in making various embodiments of the marketplace successful. Rating and promotion within the marketplace community system may be one part of this, and external publicity may be another. Contests and awards might be employed to enhance recognition of good ideas, reinforcing and complementing the basic rating system, and small awards that start on a very broad, inclusive basis might be useful to reinforce participants as widely as possible. This could take the form of multilevel contest and award structures that create and recognize winners in several dimensions, including, for example, stage of development, field, level of experience (e.g., first-timers, ineligibility after some number of prior awards, and the like), geography, profession, age, and entity size (e.g., individual, small company, or large company).

Such reward structures may be implemented with the viewpoint that financial reward may be only one factor, and that with an effective method of recognizing good ideas and/or getting them brought to fruition, many participants may be motivated even if financial rewards are small and unlikely. An example of the potential power of non-financial motivation can be found in the open source software community.

On the other hand, non-cash recognition awards might also have real economic value, for example, by attracting investment, other support, and/or by serving as marketing channels. This can also come from outside the core community system, such as by providing exposure and air-time to inventors. For instance, TV, radio, and press could cover an “idea of the week” contest. Awards from these internal and external processes could then be cited by inventors (e.g., a “Good Ideas Seal of Approval”) to further gain attention and credibility with investors, partners, distributors, and markets. This publicity role could extend, in conjunction with other marketplace review processes, to constitute an organized sub-community infrastructure that takes on the role of the press within the marketplace (and externally). Accordingly, groups of participants could scout for and report on developments of interest to an internal and/or external audience, and could do so within and across domains.

Instead of facilitating the hoarding and closely controlled sale of recognizably strong ideas, a marketplace of the present invention may provide for the rescue of the many ideas of uncertain value that fall through the cracks of the current system. The success of such ideas might not be well protected by secrecy and control; such measures might just limit the possibility of exposing the ideas to others who might recognize and add value.

Accordingly, a marketplace of the present invention may instead provide for the wide disclosure of ideas, the facilitation of dialog, and the finding of ways to channel and build on feedback that can help good ideas to gain attention, all in ways that impose minimal hurdles on the use by widest possible audience (with a minimum of exclusivity), and that exploit the power of publicity and viral marketing. The idea may be to enable “technology nurture” as a higher priority than technology transfer, with idea of catalyzing development primarily, and of funding and transferring it (and taking direct profit from it), secondarily.

According to various embodiments of the present invention, just as in adoption of children, a creator may put ideas up for adoption for the benefit of the idea itself (perhaps not for himself or herself, except altruistically and secondarily), with the understanding that ownership may be surrendered, and in the hope of finding a good home where the idea can flourish. Collaboration on nurture of ideas that prove to be productive may be an end in itself, and recognition and financial reward might only be possible bonuses. Ideas may be put in the public domain, with some limited potential for retention of some ownership, whether as IPR that can command fees, or simply as the recognized invention source. Some might be happy to be known as an Edison, even if never gaining the monetary rewards of Edison.

At the same time, large numbers of ideas submitted to marketplaces of the present invention might be of dubious value. Because of that, an adoption marketplace might also apply new ways to filter and enhance those ideas, to provide value, to nurture those ideas with potential, and/or to weed out those ideas that do not show promise even under good conditions. Such filtering and selection might be important to maximizing the appeal and value of the marketplace. It is noted that it may not be very useful to collect good ideas unless there are good filtering and search tools to enable others to find them. Various methods outlined here add a powerful level of man-machine intelligence to that critical task so that all participants can expect their use of the marketplace to be reasonably efficient and productive. As a result, two problems that can kill electronic marketplaces may be minimized: lack of items, and inability to filter the good items from the bad.

From a business feasibility perspective, such an approach may have special appeal to some key classes of potential contributors who represent a significant and richly fertile niche market that can generate many good ideas. One such class may be made up of entrepreneurial types interested in the game of creating, finding, and/or enhancing ideas, partly for gain, but also for the challenge and satisfaction of the game. These individuals also may have a strong innate drive to achieve goals and to be effective, both for their own benefit, and more broadly. Such people may be good inventors, but may lack R&D skill and support to move inventions beyond their early stages.

Another such class may be made up of techies working outside of their specialities who may have very creative cross-fertilizing ideas that they are poorly positioned to develop and which may be outside the scope of their institutions or other social support. Such individuals might be motivated in ways similar to entrepreneurial types. Still another such class may be made up of prolific inventors with many ideas. Such individuals might readily be encouraged to give away some of their less valuable ideas pro bono offerings in exchange for recognition that benefits their work on the ideas they do want to retain, and that might bring them more power and resources to help with both.

Such classes of individuals might put some effort into seeking adoption of their own ideas and others if an effective tool were known to them, and they might be motivated by non-cash recognition rewards. If these special target markets could be captured, broader mass appeal may be not needed to achieve critical mass.

Patents (issued or pending) are big and complex, but there may be hundreds of raw ideas for every patent, with a much wider value range, overlapping with more traditional IPR at the high end, but extending very low. Where current IPR marketplaces seek deals of $100 k-500K or more, an adoption marketplace of the present invention might offer deals worth as little as $1-100 and/or deals without any defined value. On the other hand, it is noted that various marketplace embodiments may offer high value (e.g., high monetary value) deals. With attention to operating economies and transaction costs suited to the handling of items that may have a wide range of values, and possibly a low average value, it is further noted that a marketplace of the present invention may offer features such as:
Enhanced, semi-automated sorting, classification, filtering, and evaluation,
Very low entry barriers and transaction costs
Alternative value and rewards systems
Harnessing community power and resources
Reputation management for large numbers of parties
Payment support systems, both financial and non-financial, possibly with micropayment features)
Integrity support to insure that all play by the rules
Significant community power, and clear roles for it to operate in
Concentration and density of coverage and participation to make the market active and vibrant
And the like

Moreover, a marketplace of the present invention may be very open and easy to do business in. Emphasis for the adoption marketplace might be on low friction and high reliance on community-supplied support, to achieve high leverage. For instance, participation might be open to all, subject to performance rating by the community that can lead to clearly indicated status, whether preferred or avoided. Qualification might be by the community, rather than the marketplace operator, except perhaps for banishment of bad actors.

Furthermore, participation might be not anonymous. Members might use community history to establish trust. Identity might optionally be masked by an alias (which might have an identity known to the operator). It is noted, however, that an unknown alias might be disadvantageous because it might lack reputation. Sophisticated reputation management methods might be applied to manage changing aliases.

Furthermore, introductions might be made directly, not brokered or mediated, and members might engage in open dialog without strict limits, except to the extent that they might impose them themselves. Automated rules might be imposed to qualify and rate dialog and participation at various levels. The emphasis might be to allow flexible ranking and filtering on community evaluated merits rather than flat-out exclusion.

Additionally, interactions might be fluid and dynamic, not hampered by sequential workflows and regimented steps. Selections of standard “shrink wrap” agreements might govern most stages and activities. Ideas at different stages and levels of apparent value might be categorized for different levels of control and support. For lower value ideas, cruder metrics, simpler workflows, and higher levels of automation might be used. Thus the marketplace might allow for varying levels of support and friction, depending on various categories of value, complexity, and participant preferences. Independent players and small entities might opt for more streamlined and automated handling than large enterprises. Integration with internal enterprise systems might also be supported, to facilitate the flow of ideas and processes from internal development to public markets, and back, as appropriate.

As noted earlier, marketplace features relating to the low-end/early stage ideas include the use of community input, reliance on peer/community power, special support for exploitation of the one year rule, recognition of possibly weak practical ability to assert legal ownership power, and recognition of weak financial power. The use of community input, augmented by computer-supported collaboration and rating tools, could be employed to identify and enhance the small percentage of ideas that have real merit. This may include support for ratings, rankings, and/or systematic sharing of evaluations and/or other collaborative inputs, and for searching and for alerting on such information.

Community input also applies to reputation management for all participants. Reliance on peer/community power, might employ formal roles identifying value and supporting fairness. Recognition of possibly weak practical ability to assert legal ownership power may involve substituting alternative rewards and peer or consumer leverage to encourage fairness, while recognition of weak financial power may involve substituting seed funding to support patent prosecution and development, for reduced emphasis on licensing or sale.

Such marketplace methods can potentially develop sub-markets and sub-cultures that support both specialization and crossover, both within marketplaces, and across them. They can potentially support different modes/styles and may self-energize with an ecological effect much like biodiversity. This could take the form of sub-communities that can be independently operated, but to maintain the value of the market, they might be linked by common search engines, categorization overlays, directories, business practices, and the like. This might be achieved by a single umbrella organization, or by confederation and use of common connector technologies and services.

It will be understood that while the discussion herein refers primarily to the US patent system as an example, these methods are globally applicable. Many of these methods are independent of any particular patent system or legal context, and in those aspects where adaptation to patent and other legal systems may be relevant, the details will be apparent to one skilled in the art. It will also be apparent that the particular methods that apply to the grace period for filing are similarly adaptable to any patent system having similar grace period provisions.

It will be further understood that these methods are applicable to other forms of IPR, including rights in expression, such as copyright or the like, with minor variations that will be apparent to those skilled in the art, based on the teachings herein. For example, such embodiments translate especially directly to uses related to copyright and expression of ideas, in aspects where significant collaborative development of ideas and their expression is valuable, such that a final work may be the work of a team, for example in developing large and/or complex software, or in developing large and/or complex works of art, such as films.

A similar idea adoption marketplace particularly suited to early-stage ideas might be applied, for example, to submissions in the form of ideas for software products, including any form of software component, or for movie concepts, plot outlines, and scripts, or book concepts, or the like. Similar benefits, including those of collaboration, adoption, development, and reward could accrue in such cases. Another example might be an exchange related to copyrighted works and/or components thereof to be used in compilations, or composite or derivative works, which might address flexible segmentation of works, value allocation, and micropayment-based exchange, among other features.

More generally, although the invention has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method of operating an electronic marketplace for the development of inventions, the method comprising:
soliciting, for use by participants in said marketplace, an invention submission relating to an invention; and
soliciting, from said participants, response submissions concerning said invention,
wherein said response submissions include:
one or more responses relating to contributions to development of the invention; and
one or more responses relating to exchange of intellectual property rights regarding the invention.

2. The method of claim 1, wherein said responses relating to contributions to development include ratings of said invention.

3. The method of claim 1, wherein said responses relating to contributions to development include ratings of the participants.

4. The method of claim 1, wherein implicit feedback on said invention is inferred by analysis.

5. The method of claim 1, wherein a multitude of invention submissions are collected, and wherein said participants may view said multitude of invention submissions in accordance with specified ranking criteria.

6. The method of claim 1, wherein said marketplace employs collaborative support system methods.

7. The method of claim 6, wherein social decision support systems are employed.

8. The method of claim 6, wherein techniques for visualizing collaborative activity are employed.

9. A method of operating a collaborative support system, comprising:
making available a plurality of alternatives for a collaborative support process of said system; and
applying one or more support processes active within said system to select for use one or more of said alternatives.

10. The method of claim 9, wherein the one or more active support processes includes a rating process.

11. The method of claim 9, wherein the one or more active support processes includes a ranking process.

12. The method of claim 9, wherein the one or more active support processes includes a decision making process.

13. The method of claim 9, wherein the collaborative process having alternatives is a rating process.

14. The method of claim 9, wherein the collaborative process having alternatives is a ranking process.

15. The method of claim 9, wherein the collaborative process having alternatives is a decision making process.

16. A method implemented by a computer server system serving a plurality of participants, comprising:
the computer server system receiving from a first subset of the plurality of participants postings of first items to be accessible to the plurality of participants;
the computer server system receiving from a second subset of the plurality of participants second items comprising first rating data entries corresponding to one or more of the first items;
the computer server system receiving from a third subset of the plurality of participants third items comprising second rating data entries rating the second items comprising the first rating data entries;
the computer server system deriving third rating data entries rating respective ones of the second subset of the plurality of participants based at least in part on a plurality of the second rating data entries received from the third subset of the plurality of participants;
the computer server system processing the first items, the second items, and the third items to weight the first rating data entries unequally based at least in part on at least some of the second rating data entries;
the computer server system providing to a particular participant at least a portion of a ranked list of items selected from among the first items, wherein the particular participant is a particular one of the plurality of participants; and
enabling substantially all of the plurality of participants to submit the second and the third items, and thus, to become members of the second and the third subsets of the plurality of participants.

17. The method of claim 16, wherein the derived third rating data entries serve as a reputation of respective ones of the second subset of the plurality of participants.

18. The method of claim 17, wherein the derived third rating data entries that serve as a reputation of respective ones of the second subset of the plurality of participants are applied based on a reputation weighting factor to weight a first participant's first rating data entry of a posted first item from a third participant relative to a second participant's first rating data entry of the posted first item to derive a composite ranking of the posted first item relative to other posted first items.

19. The method of claim 16, further comprising:
enabling open participation by substantially all of the substantially all of the plurality of participants for the submission of first rating data entries and second rating data entries,
applying weightings in place of binary exclusions to selectively favor consideration of first rating data entries and second rating data entries from particular participants who are a subject of more favorable third rating data entries, and
selectively reducing consideration of first rating data entries and second rating data entries from particular participants who are a subject of less favorable third rating data entries.

20. The method of claim 16, wherein substantially all of the plurality of participants are identifiable participant systems having a processor and at least one storage device.
